(19) United States
(12) Patent Application Publication
(10) Pub. No.: US 2017/0297913 A1
(43) Pub. Date: Oct. 19, 2017

(54) Hydrogen Generation

(71) Applicant: The University Court of the University of Glasgow, Glasgow, Strathclyde (GB)

(72) Inventors: Leroy Cronin, Glasgow (GB); Mark Symes, Glasgow (GB); Greig Chisholm, Glasgow (GB); Benjamin Rausch, Glasgow (GB)

(21) Appl. No.: 15/509,778

(22) PCT Filed: Sep. 11, 2015
(86) PCT No.: PCT/EP2015/070894

§ 371 Date: Mar. 8, 2017

(30) Foreign Application Priority Data
Sep. 11, 2014 (GB) 1416062.6

(51) Int. Cl. C01B 3/04; C01B 33/20; C25B 1/00; C25B 15/08

(52) U.S. Cl. CPC C01B 3/04; C25B 15/08; C01B 33/20; C25B 1/00

(57) ABSTRACT

The present invention provides a method for the generation of hydrogen, where the method comprises the step of reducing a mediator, such as a polyoxometallate, at a working electrode to yield a reduced mediator and generating oxygen at a counter electrode; and contacting the reduced mediator with a catalyst, such as a Pt, Rh, Pd, Mo or Ni containing catalyst, thereby to oxidise the reduced mediator to yield hydrogen.

### RELATED APPLICATION

This application claims the benefit and priority of GB 1416062.6 filed on 11 Sep. 2014 (Nov. 9, 2014), the contents of which are hereby incorporated by reference in their entirety.

### FIELD OF THE INVENTION

The invention provides a method for the generation of hydrogen from a reduced mediator, where the reduced mediator is obtained or obtainable from the reduction of a mediator, such as the catalytic reduction of the mediator.

### BACKGROUND

The present inventors have previously described the preparation of hydrogen and oxygen using a redox mediator, for example in WO 2013/068754.

In a typical method for the generation of oxygen and hydrogen, a mediator is oxidised at a working electrode to yield an oxidised mediator, and protons are reduced at a counter electrode to yield hydrogen. An oxidised mediator is reduced at a working electrode to yield a mediator, and water is oxidised at a counter electrode to yield oxygen. The oxygen generation step is performed non-simultaneously to the hydrogen generation step, and the oxidised mediator is common for both steps. Thus the production of hydrogen and oxygen is spatially and temporally separated in this system.

The mediator has a reversible redox wave lying between the onset of the oxygen evolution reaction (OER) and the hydrogen evolution reaction (HER). WO 2013/068754 discloses the use of mediators such as a redox active polyoxometallate, for example phosphomolybdic acid, and redox active organic small molecules, such as a quinone.

### SUMMARY OF THE INVENTION

The present invention provides an improved method for the generation of hydrogen and optionally oxygen, such as from water. The method makes use of electrochemical techniques to generate a reduced mediator species, whilst also providing oxygen, if required. The reduced mediator species may be used to generate hydrogen by non-electrochemical techniques, such as catalysis. A catalysis step requires no electrical input, which offers an advantage over previous methods, such as those of the present inventors, where the hydrogen generation step requires electrical input into an electrochemical cell.

Accordingly in a first aspect of the invention, there is provided a method for the generation of hydrogen, the method comprising the steps of:
(i) reducing a mediator at a working electrode to yield a reduced mediator and optionally generating oxygen at a counter electrode; and
(ii) contacting the reduced mediator with a catalyst, thereby to oxidise the reduced mediator to yield hydrogen.

Step (i) comprises the electrochemical reduction of the mediator at the working electrode and may also comprise the electrochemical oxidation at the counter electrode to yield oxygen.

Step (i) may include the generation of oxygen at a counter electrode. For example, step (i) includes oxidising water at the counter electrode to yield oxygen. In one embodiment, the oxygen generated in step (i) is collected. The oxygen may be substantially free of hydrogen.

The catalyst may be spatially separated from the electrochemical cell holding the working and counter electrodes. Thus, the reduced mediator may be removed from the electrochemical cell prior to step (ii).

In one embodiment, the mediator accepts H⁺ during the reduction. Thus, the reduced mediator has one or more hydrogen atoms, such as two more hydrogen atoms, than the mediator.

In one embodiment, the mediator is a metal oxide.

In one embodiment, the mediator is a polyoxometallate.

In one embodiment, the mediator is a heteropoly acid.

In one embodiment, the mediator is an organic compound, such as a compound having redox active functionality.

In one embodiment, the polyoxometallate is of formula {Hₘ[M₁₂O₄₀X]}ⁿ⁻ where m is 0, 1, 2, 3, 4, 5 or 6 as appropriate, M is a metal, such as Mo, W or V, or mixtures thereof, X is P or Si, n is an integer, for example from 0 to 6. Where n is not 0, one or more suitable counter ions may be provided, such as a metal cation from Group 1 or Group 2, for example Na⁺, K⁺, and Mg²⁺.

In one embodiment, the polyoxometallate is of formula Hₘ[M₁₂O₄₀X] where m is 3, 4, 5 or 6 as appropriate, M is a metal, such as Mo, W or V, or mixtures thereof, and X is P or Si.

In one embodiment, the polyoxometallate is of formula [M₁₂O₄₀X]n⁻ where M is a metal, such as Mo, W or V, or mixtures thereof, X is P or S, and n is 3, 4, 5 or 6 as appropriate. One or more suitable counter ions may be provided, such as a metal cation from Group 1 or Group 2, for example Na⁺, K⁺, and Mg²⁺.

In one embodiment, the mediator is H₄W₁₂O₄₀Si ^{or} H₅W₁₂O₄₀Si.

In one embodiment, the mediator accepts protons during the reduction. Water, such as acidified water, may be the proton source.

In one embodiment, the reduction of the mediator occurs at a voltage that is more positive than the voltage for the generation of hydrogen at the working electrode.

In one embodiment, the hydrogen generated in step (ii) is collected.

In one embodiment, the hydrogen is substantially free of oxygen, for example the oxygen content is 1 mole % or less

In one embodiment, in step (ii) the oxidation of the reduced mediator provides an oxidised form of the reduced mediator, such as the mediator. In a further embodiment, oxidised form of the reduced mediator generated in step (ii) is subsequently utilised in step (i).

In one embodiment, the catalyst is a metal catalyst.

In one embodiment, the catalyst is or comprises a metal selected from the group consisting of Pt, Rh, Pd, Mo and Ni. The metal may be neutral or charged.

In one embodiment, the catalyst is provided on carbon.

In one embodiment, the metal is provided on carbon in an amount of at most 50%, at most 40%, at most 20%, at most 10, at most 5, at most 3, at most 2, at most 1, at most 0.5 or at most 0.1 wt %.

In a further aspect the present invention also provides for the use of a reduced mediator, as described herein, as a hydrogen source in a method of catalysis. The reduced mediator may be obtainable or is obtained from the electrochemical reduction of a mediator, optionally together with concomitant generation of hydrogen.

Further aspects and embodiments of the invention are set out if further detail below.

### SUMMARY OF THE FIGURES

FIG. 1 is schematic of mediated hydrogen evolution from water, for use in an embodiment of the invention.

FIG. 2 shows (A) Reductive CVs under Ar and at room temperature; black: H₄[SiW₁₂O₄₀] in water (0.5 M, pH 0.5), at a glassy carbon working electrode (area=0.071 cm²); red: 1 M H₃PO₄ (pH=1.0) on a glassy carbon working electrode; green: 1 M H₃PO₄ (pH=1.0) on a platinum disc working electrode (area=0.031 cm²). A Pt-mesh counter electrode and Ag/AgCl reference electrode were used at a scan rate of 0.1 V s⁻¹; and (B) a comparison of the rate of hydrogen production possible using electrolysis mediated by silicotungstic acid (this work) and a selection of state-of-the-art electrolyzers from recent years. Square symbols indicate data obtained for a mediated system described herein. Red data (left hand y-axis): the rate of hydrogen production per milligram of Pt. Blue data (right hand y-axis): the absolute rate of hydrogen production determined for hydrogen production from H₆[SiW₁₂O₄₀] (this work, squares) and the various literature electrolyzer systems. Dashed lines are provided solely as guides to the eye, where the catalysts are 50 mg of 5% Pt/C (square), 50 mg of 3% PT/C (hexagon), 50 mg of 1% Pt/C (triangle, pointing upwards), 10 mg of 1% Pt/C (triangle, pointing downwards), 50 mg 5% Rh/C (diamond), and 50 mg of 10% Pd/C (triangle, upwards pointing left).

FIG. 3 shows (A) the rate of H₂ production from a 20 mL sample of 0.5 M H_{6[}SiW₁₂O₄₀] under an Ar atmosphere; and (B) a magnification of the first two minutes of the hydrogen evolution process from H_{6[}SiW₁₂O₄₀] in the presence of 50 mg Pt/C (5, 3 and 1 wt. %). Dashed lines indicate the derived initial rates.

FIG. 4 shows the hydrogen evolution (% yield from theoretical maximum) from H₆[SiW₁₂O₄₀] for a range of catalysts, where (a) shows the yield for no catalyst, and Pt, Pd, Au, Ag, Cu, W catalysts as 2 cm² foils; and (b) shows the yield for Ni₂P and MoS₂ catalysts as 50 mg powders. The catalysts were mixed with H_{6[}SiW₁₂O₄₀] and kept in round bottom flasks with agitation over a period of three days. Via GCHA (gas chromatography headspace analysis), the hydrogen content in the headspace was determined. The percentage yield is based on the amount of H_{6[}SiW₁₂O₄₀] added to the samples and is calculated based on the amount of hydrogen that would theoretically be released for the complete 1-electron oxidation of H₆[SiW₁₂O₄₀] by protons (H₆[SiW₁₂O₄₀]+H⁺→H₅[SiW₁₂O₄₀]+½H₂. The data is averaged over three repetitions and error bars show the standard deviation.

FIG. 5 shows the change in current density (mA cm⁻²) with change in applied potential (V vs NHE) for (a) the reduction of H₅[SiW₁₂O₄₀] to H₆[SiW₁₂O₄₀] in a 50:50 mix of 0.5 M H₅[SiW₁₂O₄₀] and H₆[SiW₁₂O₄₀] using a glassy carbon electrode (area=0.071 cm²) (middle line); reduction of protons in 1 M H₃PO₄ on a glassy carbon electrode (left hand line); and reduction of protons in 1 M H₃PO₄ on a platinum disc electrode (area=0.031 cm²) (right hand line); and (b) the oxidation of water using a platinum electrode (area=0.031 cm²) in 1 M H₃PO₄ (pH=1.0). All data are averaged over three runs and has been corrected for ohmic losses.

FIG. 6 shows the change in hydrogen quantity in a headspace (% yield from theoretical maximum) over time (hours) based on GCHA analysis of solutions of mediator after the initial rapid hydrogen production phase has ceased, with periodic purging of hydrogen from the headspace. The headspace was purged of hydrogen at t=0 h, t=48 h and t=72 h by bubbling vigorously with argon.

FIG. 7 shows the change in the oxygen fraction (%) in an flask head space over time (min), upon exposure to a reduced mediator, H₆[SiW₁₂O₄₀].

FIG. 8 shows the charge passed in a multiple 1-electron reduction and oxidation of a 50 mM solution of H₄[SiW₁₂O₄₀] in 1 M H₃PO₄. The mediator solution was constantly bubbled with argon during electrolysis.

FIG. 9 shows the percentage of mediator reduced in multiple reduction and oxidation cycles of a 200 mM solution of H₄[SiW₁₂O₄₀] in water over time (h).

FIG. 10 shows the change in the amount of gas in the head space of an electrochemical cell with change in current passed (C) for theoretical and experimental oxygen and hydrogen evolution.

FIG. 11 shows the yield of hydrogen with change in current passed (C), using a Pt counter electrode (black squares), carbon counter electrode (green and red).

### DETAILED DESCRIPTION OF THE INVENTION

The present case provides a method for generating hydrogen, optionally together with oxygen, in a two stage process. The first stage involves the electrochemical reduction of a mediator, typically with concomitant generation of oxygen from water. In a second step, the reduced mediator is oxidised thereby generating hydrogen. The oxidation of the reduced mediator is not an electrochemical oxidation, and hydrogen may be generated catalytically or thermally.

The generation of the reduced mediator within an electrochemical cell occurs at the surface of a working electrode. In the methods of the invention hydrogen is not generated at the counter electrode. In this way, the hydrogen generation step may be spatially and temporally separated from the electrochemical generation of the reduced mediator and the electrochemical generation of oxygen. For example, the reduced mediator may be removed from the electrochemical cell, and hydrogen may be generated in a separate unit. As described herein, a reduced mediator may be removed from an electrochemical cell and contacted with a catalyst, thereby to generate hydrogen.

The mediator accepts protons and electrons in the reduction step. The resulting reduced mediator may then donate electron and protons in a subsequent hydrogen generating step, such as when the reduced mediator is contacted with a catalyst.

In the present work a redox active mediator can be reversibly reduced at the working electrode (cathode) of an electrochemical cell, typically as water is oxidised at a counter electrode (anode). The reduced mediator is then transferred to a separate reaction space, for spontaneous catalytic hydrogen evolution, and without the need for further electrical input.

This approach offers several advantages. The electrochemical reaction may be performed at ambient pressure, whilst permitting the hydrogen generation step to be performed at a different, such as elevated, pressure, which may be more suited to the optimal evolution of hydrogen in the catalytic step. Further, the amount of hydrogen generated in the electrochemical cell is negligible or non-existent. Thus, there is no need to purge hydrogen from the anode side of the cell.

The degradation of the cell membrane is linked to the presence of reactive oxygen species (ROS) within the cell, which are generated where oxygen and hydrogen are permitted to mix in the presence of electrode catalysts. The formation of explosive gas mixtures is also minimised. The rate of hydrogen generation is also decoupled from the rate of the reaction at the counter electrode, such as the oxidation of water to yield oxygen. The catalysis reaction that yields hydrogen can be performed at a rate that is far greater than the rate of hydrogen evolution observed in present proton exchange membrane electrolysers (PEMEs).

The hydrogen produced in the catalytic reaction has an inherently low oxygen content, on account of the separation of the hydrogen generation step from the oxygen generation step, and by virtue of the fact that the reduced mediator reacts with dissolved oxygen, thereby reducing its content in the hydrogen product. It follows that the methods of the invention are well suited to the production of high purity hydrogen, which may be supplied to fuel cells, and industrial processes such as the Haber-Bosch method for the preparation of ammonia. Hydrogen prepared by the methods of the invention does not require further purification, thereby avoiding the post-electrolysis purification processes that are required in PEMEs, and other electrochemical processes.

WO 2013/131838 and Amstutz et al. (Energy Environ. Sci. 2014, 7, 2350) describe methods for the catalytic generation of hydrogen and oxygen. Oxygen is generated in the catalysed reaction of Ce³⁺ with water. Hydrogen is generated from the catalysed reaction of V²⁺ and protons. Ce³⁺ and V²⁺ are generated electrochemically, and these ions are circulated to catalytic beds for reaction. Other species are suggested for use in the catalytic generation of hydrogen and oxygen, though these species are not exemplified.

The present case may include the step of electrochemically generating oxygen at a counter electrode. In contrast, Amstutz et al. describe oxygen generation by catalytic means only. This step is said to be problematic, and less efficient than the generation of oxygen by other methods, such as electrochemical methods. The authors note that it is necessary to take particular steps to prepare the catalyst for the oxygen generating catalysis reaction. For example, commercially available RuO₂ catalyst must be treated prior to use, for example by a prolonged heat treatment. The preparation of the catalyst is therefore not a simple step.

The authors also note that the catalysts have a tendency to degrade over time, possibly owing to the reaction of Ce ions with the catalyst. Thus, the catalyst activity drops over time. Degradation of catalyst materials is not observed in the present case.

A mediator for use in the present case may be a metal oxide, such as a polyoxometallate. WO 2013/131838 and Amstutz et al. do not describe the use of a metal oxide for use in the generation of a reduced mediator. As discussed below, metal oxides and polyoxometallates are well suited for use as mediators, owing to their thermal and oxidative stability, their accessible multiple oxidation states, amongst other advantages.

A meditator for use in the present case will typically accept protons during the reduction reaction, and these protons may be liberated in the later oxidation reaction, thereby to generate hydrogen. The work of WO 2013/131838 and Amstutz et al. does not describe or suggest the use of a mediator that accepts protons during electrochemical reduction, nor does it suggest the use of a proton-carrying mediator in the catalytic oxidation of a reduced mediator.

Amstutz et al. also describe other problems with the Ce³⁺ and V²⁺ system. Vanadium cations were seen to cross the membrane within the electrochemical cell, thereby contaminating the anodic side of the cell. Whilst the authors note that this is a problem at deep discharge and charge conditions, the problem is apparently multiplied in a multi-cyclic system. In the present case, the movement of a mediator, such as a polyoxometallate, is not observed.

Amstutz et al. also acknowledge that the chemistry of Ce metal ions is problematic, owing to low solubility, and the complex chemistry which can lead to the formation of precipitates within the cell. Ce ions also have a tendency to degrade carbon-based electrodes, which limits the material that can be used in the cell. The degradation of the catalyst materials is not observed in the present case, nor is there any observed degradation in the counter electrode, which is typically used to electrochemically generate oxygen.

### Methods

The present invention provides a method for preparing hydrogen from a reduced mediator which is generated electrochemically. The hydrogen is generated from the contact of the reduced mediator with a catalyst.

Thus, in one aspect, the present invention provides a method for the generation of hydrogen, the method comprising the steps of:
(i) reducing a mediator at a working electrode to yield a reduced mediator and optionally generating oxygen at a counter electrode; and
(ii) contacting the reduced mediator with a catalyst, thereby to oxidise the reduced mediator to yield hydrogen.

The first step of the method is the electrochemical generation of the reduced mediator from a mediator, for example within an electrochemical cell. Typically, the generation of the reduced mediator at the working electrode is associated with the generation of oxygen at a counter electrode. Thus, the methods of the invention may be used to prepare both hydrogen and oxygen. As explained in further detail below, the generation of hydrogen is separated from the generation of oxygen, which has the benefit of simplifying the collection of the hydrogen and oxygen, and improving the purity of the collected gases, amongst other advantages.

The hydrogen is not generated electrochemically, and therefore the hydrogen generation step does not require the application of an applied voltage. Hydrogen is not generated in an electrochemical cell, therefore the problems of electrochemical cell degradation that are associated with electrochemical hydrogen generation are avoided.

In step (ii) an oxidised form of the reduced mediator may be generated upon contact with the catalyst. This oxidised form of the mediator may be the same as the mediator that is used in step (i) of the method.

In one embodiment, an oxidised form of the reduced mediator may be used subsequently as a mediator in step (i). Thus, the mediator may be recycled within a system to allow for the continuous generation of hydrogen, for example with the generation of oxygen. The mediator may be regarded as a shuttle which links the catalytic generation of hydrogen with the generation of oxygen.

In one embodiment, the catalysis is a heterogeneous catalysis. Thus, the reduced mediator may be provided in solution, and the catalyst may be provide as a solid phase held within the solution (for example, a powder), or contacting the solution (for example, a mesh).

The mediator and the reduced mediator are described in further detail below. During the reduction reaction, the mediator may accept one or more protons. The reduced mediator may then release one or more protons on contact with a catalyst, thereby to generate hydrogen.

The methods of the invention may include further downstream steps. For example, the hydrogen may be collected for further use. Oxygen may also be collected for further use. The collected hydrogen or oxygen may be compressed, for example for storage and transport.

Any collected gas may be subjected to a purification step to remove impurities. However, this step may not be necessary as the hydrogen and oxygen produced by the methods described herein have low levels of contamination. In particular, the inventors have found that the generation of a reduced mediator in an electrochemical cell, together with the generation of oxygen, does not generate significant quantities of hydrogen (gas). Thus, the oxygen collected from the cell does not have hydrogen as a significant component.

The hydrogen generation step involves the contact of the reduced mediator with a catalyst. This step may be performed in an atmosphere having little or no oxygen present (anaerobic conditions). For example, the catalyst may be contacted with the reduced mediator in an inert nitrogen or argon atmosphere.

The preparation of an oxygen depleted atmosphere is well known to those of skill in the art, and may include purging with inert gases, such as those described above. An inert gas may subsequently be separated from the hydrogen, if necessary.

The methods of the invention are therefore beneficial, as the impurity levels are low, and the gaseous products require little or no purification prior to downstream use.

For example, the amount of hydrogen in the gas (which may be oxygen) collected from the electrochemical cell is at most 10, at most 5, at most 2 or at most 1 mole %.

The amount of oxygen in the collected hydrogen is at most 10, at most 5, at most 2 or at most 1 mole %.

The inventors have found that the reduced mediator may react with oxygen, thereby removing the oxygen from the system. Thus, the reduced mediator acts to purify the product.

The collected hydrogen and oxygen may be used as required. For example, the hydrogen generated and collected may be used in a fuel cell to generate electricity. Thus, hydrogen may be generated at a time or location where there is a ready power supply (in the form of electrical current, including light-initiated photovoltammetry). The collected hydrogen may then be consumed at times and/or locations where there is a need for a power supply. Thus, the consumption of the hydrogen may be temporally and/or spatially separated from the hydrogen generation.

The methods of the invention may be performed as a batch or continuous flow process.

In the batch process the reduced mediator is consumed in the catalytic process, until the mediator is consumed, the reduced mediator is consumed and/or the rate of hydrogen generation falls. The method may then be halted. During the method evolved hydrogen and oxygen may be collected, and used or stored as required.

In the batch process it is not necessary for the reduced mediator to be contacted with the catalyst immediately after its preparation. In one embodiment, the reduced mediator is prepared as a distinct step. Once the mediator is consumed, or the yield of the reduced mediator reaches a maximum, the reduced mediator is permitted to react with a catalyst. Thus, there is a temporal separation of the oxygen generation and the hydrogen generation.

Alternatively, the reduced mediator may be taken from the electrochemical cell during the electrochemical generation of oxygen, and permitted to contact the catalyst thereby generating hydrogen at the same time as the oxygen. The hydrogen generation step is spatially separated from the electrochemical cell.

After the hydrogen generation step is deemed complete, the oxidised form of the reduced mediator may be collected for further use, for example in a repeat of the method of the invention.

In a flow process, the reduced mediator is consumed in the catalytic process, thereby to generate an oxidised from of the mediator. The oxidised form may be the original mediator, or it may be an intermediate oxidised form having an oxidation state between that of the reduced mediator and the mediator, or a further oxidised form of the mediator. The oxidised form, such as the mediator, may then be fed back into the electrochemical cell, where the oxidised form may be converted to a reduced form. In this way the generation of hydrogen and oxygen may be continuous. The hydrogen generation and the oxygen generation are nevertheless spatially separated.

The method of the invention may be undertaken in an apparatus that is a flow system, whereby material is permitted to flow into and out of an electrochemical cell. Thus the mediator may be permitted to pass into the cell, where it is reduced, and the reduced form is permitted to pass out of the cell, and downstream of the cell the reduced mediator is permitted to contact a catalyst, thereby to generate hydrogen and an oxidised form of the reduced mediator.

In a continuous method, the oxidised form of the reduced mediator may then be permitted to flow back to the electrochemical cell.

The generation of hydrogen from a reduced mediator may involve a purging step, whereby hydrogen that is generated in the reaction is removed from the system. The removal of hydrogen may be a continuous operation, where there is gaseous flow through the system, for example using an inert carrier gas to remove the hydrogen. Alternatively, the removal of hydrogen may be sequential, where hydrogen is permitted to collect in the system, and that hydrogen is subsequently removed in one step. Further hydrogen is permitted to evolve from the reduced mediator into an atmosphere that has been substantially depleted of hydrogen. Again, an inert carrier gas may be used to remove hydrogen from the system.

The inventors have found that the generation of hydrogen is an equilibrium process with the reduced mediator, and also with partially oxidised forms of the mediator. The removal of hydrogen from the system, either by continuous or sequential means, serves to shift the equilibrium in favour of the generation of further hydrogen.

The method of the invention may be performed at ambient temperature, although reduced and elevated temperatures may be used in either or both of the reduction step (i) or the hydrogen generation step (ii). The method steps are performed at temperatures that allow the electrolyte, containing mediator and/or reduced mediator, to flow.

In some embodiments, it may be desirable to perform step (i) and/or step (ii) at a temperature of 20° C. or more, such as 30° C. or more, such as 40° C. or more. Whilst this embodiment, may require a thermal energy input, step (ii) still does not require an electrical input to permit hydrogen generation.

The method of the invention may be performed at ambient pressure, although reduced or elevated pressures may be used in either or both of the reduction step (i) or the hydrogen generation step (ii).

In the methods of the invention, a voltage is applied across the working and counter electrodes. The voltage and current are sufficient to reduce the mediator at the working electrode.

The working electrode and the catalyst are selected with consideration to the redox chemistry of the mediator and the reduced mediator. The working electrode is selected such that the potential for the reduction of the mediator is more positive than the potential for the generation of hydrogen at that electrode.

For example, the present case makes use of silicotungstic acid, which has a second redox wave centred at about −0.22 V (with respect to the NHE) on a carbon working electrode. Hydrogen generation on a carbon electrode generally occurs from a potential of around −0.60 V or more (more negative). Thus, the reduction of the mediator is not associated with the generation of hydrogen at the working electrode.

In one embodiment, hydrogen and oxygen are generated simultaneously. Thus, the reduced mediator may be oxidised at the same time as additional reduced mediator is prepared in the electrochemical cell. Thus, a reduced mediator from the electrochemical cell is contacted with a catalyst during the operation of the electrochemical cell.

### Electrochemical Cell

The reduced mediator may be generated by electrochemical reduction of a mediator within an electrochemical cell. The cell comprises a working electrode, and the mediator is reduced at the working electrode to yield a reduced mediator. In the reactions described herein the working electrode is a cathode.

In the reactions described herein the counter electrode in an anode. The counter electrode is used to oxidise a species in the electrolyte. Oxygen may be generated at the counter electrode, for example by oxidation of water.

The electrochemical cell optionally further comprises a reference electrode, such as a silver/silver chloride reference electrode.

The working and counter electrodes define an electrochemical space in which an electrolyte is provided. In one embodiment, the electrochemical space is divided by a semi-permeable membrane to provide a working electrode electrolyte space and a counter electrode electrolyte space. The mediator is provided in the working electrode electrolyte space. No mediator, as defined in the present case, is provided in the counter electrode space. The semi-permeable membrane prevents movement of the mediator from moving from the working electrode electrolyte space to the counter electrode electrolyte space. The mediator is thereby prevented from contacting the counter electrode surface.

It follows that the reduced mediator is generated in the working electrode electrolyte space. The membrane prevents the reduced mediator from contacting the counter electrode surface.

A set up whereby the mediator is separated from the counter electrode side of the cell is advantageous in that the mediator cannot interfere with the chemistries that are occurring at the counter electrode. In those cells that are based on the photoelectrochemical generation of oxygen, the mediator is kept separate from the side of the electrolyte space where the photochemistry occurs. The mediator may absorb light at wavelengths that overlap with the wavelengths at which the photocatalyst absorbs light. Thus, the mediator is prevented from interfering with the photochemistry.

Thus, an electrochemical cell may comprise a working electrode, a counter electrode, optionally a reference electrode, and an electrolyte. The electrolyte holds the mediator, and subsequently the reduced mediator as the product of the reduction reaction in step (i).

The working and counter electrodes are electrically connected or connectable.

In one embodiment the electrochemical cell may further comprise a voltage supply (or power supply). The voltage supply is preferably adapted to supply a constant bias between the working electrode and the counter electrode or the reference electrode, where present. The voltage supply is adapted to supply a constant bias of up to 5.0 V. In one embodiment, the voltage supply is adapted to supply a constant bias of around 1.5 V.

In one embodiment the electrochemical cell derives its power from an external light source, and in particular sunlight. In one embodiment, the electrodes are in electrical connection with, for example, a photovoltaic device. In another embodiment, the counter electrode is provided with a light activateable material suitable for use in an electrochemical cell. Such electrodes are as described above.

The electrochemical cell may further comprise a detector for monitoring current. The electrochemical cell may further comprise a controller for controlling the voltage supply and timing of that supply.

### Electrodes

The electrodes for use in the present invention include those comprising or consisting of platinum, platinum oxide, palladium, iridium, iridium oxide, indium-tin oxide and/or carbon and tungsten trioxide. Such electrodes are known for use in systems for the generation of oxygen, as is well described in the art (see, for example, Damjanovic et al. as an early example).

Other electrodes are also suitable for use, although preferably such should be resistant to strong acid, which is favoured in the electrolyte.

The choice of electrode is dependent on the nature of the reduction and oxidation steps that are performed. Thus, as described herein, there are provided methods for the photoelectrochemical generation of oxygen at a counter electrode. Such methods may call for the use of a semi-conductor type electrode, or an electrode having a coating of a photocatalyst.

As noted previously, the working electrode is chosen such that the reduction potential for the mediator is more positive than the redox potential for the generation of hydrogen from water at the working electrode.

In one embodiment, the electrodes of the invention do not contain Fe. The use of iron-containing electrodes, such as stainless steel electrodes, has been associated with the loss of membrane integrity in (see Pozio et al.). However, Fe-containing electrodes may be used with suitable membrane materials.

A working electrode, as described herein, is an electrode at which a mediator is reduced. A counter electrode, as described herein, is an electrode at which an oxidation reaction is performed, such as the generation of oxygen from water.

In one embodiment of the invention, the working electrode is a platinum or platinum-containing electrode. Alternatively, the working electrode may be a carbon electrode, such as a glassy carbon electrode. In one embodiment of the invention, the counter electrode is a platinum or platinum-containing electrode. In these embodiments the power source for the electrochemical reaction is provided by an external source.

As noted herein, the working electrode material is chosen such that the reduction potential for hydrogen generation from water is more negative than the reduction potential for the mediator. In the examples herein, a carbon electrode is used together with H₄W₁₂O₄₀Si, as the redox waves for the reduction of this species are more positive than the reduction potential for hydrogen generation. A platinum-based working electrode is less suitable here, as the reduction potential for the mediator and for hydrogen generation are very close. Typically, the potential for the mediator reduction at the working electrode is at least 0.1 V, at least 0.2 V, at least 0.5 V, at least 0.5 V, at least 1.0 V, or at least 1.5 V more positive than the reduction potential for the generation of hydrogen from water at the same electrode.

The counter electrode material may be selected for its suitability in the oxygen evolving reaction. Iridium or iridium oxide is particularly suitable for use at an anode for the oxygen evolving reaction.

The use of an electrode that does not contain a metal such as platinum is advantageous in that it minimises apparatus costs. However, there may be electrochemical benefits associated with the use of platinum and other such electrodes. These benefits, which can include greater power efficiencies, may provide an overall more efficient system. Thus, the electrode may be selected with a view to the wider benefits that result from its use and not merely the costs of preparing the electrode. Such considerations will be apparent to one of skill in the art.

The working or counter electrode may be in the form of a wire, sheet (or foil), disk or mesh.

A reference electrode may be included in the electrode cell of the invention. The reference electrode may be a standard silver/silver chloride electrode. The reference electrode may be a pseudo reference electrode, which is operable as a reference electrode in the presence of a suitable buffer comprising appropriate ions.

The working electrode and the counter electrode, along with the reference electrode define an electrolyte space. In use, the electrodes are in electrical contact with an electrolyte in said electrolyte space. The electrolyte is as described herein.

### Electrolyte

An electrolyte holds the mediator in the electrochemical cell. The electrolyte may be or comprise an aqueous electrolyte and water may be the source for the protons in the reduction of the mediator. The reductions of the mediator may be associated with the generation of oxygen at the counter electrode. Here, water may be the source of the oxygen.

The present case also provides for the use of a solid electrolyte, such as a polymer electrolyte, which may be a protein exchange membrane.

The electrolyte comprises the mediator. The mediator may be present at a concentration of at most 1.0, at most 1.5, or at most 2.0 M.

The mediator may be present at a concentration of at least 0.1, at least 0.2 or at least 0.3, or at least 0.5 M.

The mediator may be present at a concentration in a range selected from the upper and lower values given above, for example 0.5 to 2.0 M.

In one embodiment, the mediator is present at a concentration of about 0.5 M.

In one embodiment, the concentration refers to the concentration of the mediator in the working electrode space of the electrolyte space.

In principle water electrolysis may be performed at any pH: under very basic or acidic conditions, or at neutral pH. Typically an acidic electrolyte is used. In one embodiment the electrolyte has a pH of at most 6, at most 5, at most 4, at most 3 or at most 2.

In one embodiment, the electrolyte used in the electrochemical reaction has a pH that is at most 6, at most 5, at most 4, at most 3, or at most 2. In one embodiment, the electrolyte has a pH that is at least 0.1, at least 0.2 or at least 0.3. In one embodiment, the electrolyte has a pH that is in a range having upper and lower values selected from the values above.

In one embodiment the pH of the electrolyte is in the range 0 to 2.

In one embodiment, the pH of the electrolyte is about 0, about 0.5, or about 1.

An electrolyte that has a substantially neutral pH may also be used.

The acidic electrolyte may be an aqueous acid solution, such as mineral or organic acids.

In one embodiment, the electrolyte further comprises one or more mineral salts.

The electrochemical cell for use in the present invention is provided with a membrane between the working and counter electrodes. The mediator is provided on the working electrode side of the membrane only, and the membrane prevents movement of the mediator or the reduced mediator to the counter electrode side of the electrochemical cell. To balance the osmotic pressure across the membrane, the counter electrode side of the cell may be provided with additives, such as salts. Such additives are typically not provided on the working electrode side of the cell.

In one embodiment, the electrolyte is an aqueous H₃PO₄ solution.

In one embodiment, the electrolyte is an aqueous 1.0 M H₃PO₄ solution.

The pH of the electrolyte may refer to the pH before the electrochemistry has been initiated i.e. before hydrogen or oxygen generation has begun. Alternatively, the pH may refer to the pH of the electrolyte during the oxygen generation process.

The electrolyte may be buffered. A buffer is provided to maintain the pH of the electrolyte throughout the electrochemical process. The present inventors have discovered that the mediator itself may act to buffer the electrolyte. As described herein, the mediator may accept protons, thereby controlling the pH of the electrolyte solution.

In one embodiment, the buffer is suitable for maintaining the pH of the electrolyte solution at a substantially constant level during an electrochemical reaction. The mediator itself may fulfill this function, for example where the mediator is capable of accepting protons. In one embodiment, the change in pH of the electrolyte during an electrochemical reaction may be less than 1 unit, less than 0.5 units, less than 0.3 units, less than 0.2 units or less than 0.1 units of pH.

As described herein, the electrochemical cell of the invention comprises an electrolyte space. The space is divided into a working electrode region and a counter electrode region by a membrane. The membrane prevents movement of the mediator, in its oxidised and reduced form, from one side of the electrolyte region to another. Thus, it will be appreciated that the composition of the electrolyte in one electrolyte region will differ to the composition of the electrolyte space in the other region.

Methods for the preparation of the electrolyte will be obvious to one of skill in the art.

### Membrane

A membrane is provided to prevent the movement of the mediator from the working electrode side of the electrochemical cell (the working electrode electrolyte space) to the counter electrode side of the electrochemical cell (the counter electrode electrolyte space). The membrane permits movement of other ions, such as protons, from moving the working electrode electrolyte space to the counter electrode electrolyte space, and vice versa.

In one embodiment, the membrane is a cationic permeable membrane.

In one embodiment, the membrane is a proton permeable membrane.

In one embodiment, the membrane is a solid electrolyte. Such are well known in the art for use within PEMEs (proton exchange membrane electrolysers).

In one embodiment, the membrane is a membrane that is impermeable to molecules having a molecular weight of 200 or more, 500 or more, or 1,000 or more.

The membrane is not particularly limited so long as the membrane is capable of preventing movement of the mediator therethrough, whilst permitting movement of cations, particularly protons therethrough. The membrane may therefore said to be impermeable to the mediator.

Suitable for use in the present case are membranes containing a sulfonated tetrafluoroethylene based fluoropolymer-copolymer. Nafion membranes are examples of commercially available membranes of this type.

In one embodiment, the membrane is a cellulose membrane, which includes functionalised cellulose membranes. In one embodiment the membrane is a benzoylated cellulose-membrane.

At high voltages, a membrane material is at risk of degradation. The present invention provides for the use of relatively low voltages, thereby minimising the likelihood that the membrane material will degrade. The use of iron-containing electrodes has been associated with a loss of membrane integrity over time. Therefore, the use of iron-containing electrodes is avoided in the electrochemical cells described here, as appropriate.

### Mediator

The mediator is a redox active species that is capable of accepting and donating protons and electrons in reduction and oxidation reactions.

The mediator is typically a polyoxometallate, as described below. However, other mediator species, such as organic compounds having redox active functionality, may be employed.

The mediator may be a single species, or the mediator may comprise one or more species that may be reduced. As explained herein, mediators such as polyoxometallates may have multiple oxidation states, and one or more of the oxidised forms may be used as a mediator. Similarity, the reduced form of the mediator may comprise one or more species that may be oxidised.

A mediator is oxidatively stable, and preferably thermally stable also. The present invention makes use of a mediator that has (at least) two different oxidation states, which oxidation states may be accessed by oxidation or reduction from one state to the other. In particular a mediator is thermally and oxidatively stable in both the oxidised form and the reduced form. It is noted that the reduced form of the mediator is stable in the absence of a suitable catalyst. The mediator has minimal cross reactivity with other components within an electrochemical cell (e.g. the electrodes and other components of the electrolyte). The mediator may also be stable to light, particularly visible light. This characteristic is useful, as recent developments in the production of oxygen and hydrogen, utilise photoactive components to provide the electromotive power for the methods. A mediator that is stable to illumination from visible light sources, such as sun light, is particularly desirable.

In one embodiment, the mediator is not a metal ion. Thus, the mediator may not encompass a transition metal ion. As set out below, the mediator typically contains multiple atoms, such as multiple metal atoms.

In one embodiment, the mediator is a metal oxide.

In one embodiment, the mediator for use in the present invention is a polyoxometallate. The polyoxometallate is an oxo-anion of a transition metal cluster. In one embodiment, the polyoxometallate is an acidic polyoxometallate, and references to polyoxometallate may be construed accordingly. Polyoxometallates for use as mediators, and the acid forms thereof, are thermally and oxidatively stable.

The present inventors have determined that polyoxometallates, in a reduced or oxidised form, may be stored under ambient laboratory conditions (with respect to heat, light, pressure and humidity amongst others) for at least 25 days without appreciable decomposition. The integrity of a polyoxometallate may be gauged over time using standard analytical techniques, such as UV-Vis and NMR spectroscopies (for example ³¹P NMR, where a P atom is present in the polyoxometallate cluster) and the like. Similar techniques may be employed to test the integrity of other mediators. It will also be appreciated that the integrity of the mediator may be tested by employing the mediator in a number of repeat cycles of hydrogen generation steps according to the present invention, for example where the mediator is reduced then oxidised to yield hydrogen, and that sequence repeated. Over number of cycles, for example 4 or more, the mediator may be present without appreciable degradation. For example, 85% or more of the mediator, such as 90% or more, may be present after these cycles.

In one embodiment, at least a one electron reduction of the mediator, such as a polyoxometallate, yields the reduced form. In one embodiment at least a two electron reduction of the oxidised form yields the reduced form. Such a mediator is beneficial as it has a higher electron accepting and donating density. Thus one cluster molecule may “hold” two or more electrons.

In one embodiment, the reduction of the mediator, such as a polyoxometallate, may be associated with the gain of H⁺ to the mediator. The oxidation of a reduced mediator may be associated with the formal loss of H⁺ from the reduced mediator, which yields hydrogen in the methods of the invention. Here, the mediator is a H⁺ donor and/or acceptor. In one embodiment, the reduction or oxidation is associated with the gain or loss of two or more H⁺ from or to the mediator. Such a mediator is beneficial as it has a higher proton accepting and donating density. Thus a mediator such as a polyoxometallate cluster may “hold” two or more protons. As explained below, a mediator that is capable of donating and accepting H⁺ may act as a buffering agent in the electrolyte during an electrochemical reaction.

Where the mediator gains H⁺ during its reduction, it is not necessary to generate oxygen at the counter electrode. Thus, the electrochemical oxidation at the counter electrode may yield products other than gaseous oxygen.

The ability of a mediator to accept or donate protons provides a useful benefit in the systems and methods of the invention. The mediator has the ability to act to at least partially buffer the electrolyte by accepting protons that are generated during the generation of oxygen at the counter electrode.

The reduced and oxidised forms of the mediator are soluble in water, and are soluble in acidified water. Thus, reduction of the mediator does not produce an insoluble material within an electrochemical cell.

The mediator may be an anion. The charge of the oxidised state of the mediator is −1 or less, for example −2, −3, −4. In one embodiment, the oxidised state has a charge of −3. In one embodiment, the charge of the reduced state of the mediator is 1 or more less than the charge of the oxidised stated of the mediator, for example, 2 more, or 3 more. Thus, where the oxidised state has a charge of −3, the reduced state may have a charge of −5. In one embodiment, the reduced state has a charge of −5.

In one embodiment, the mediator has a one electron redox wave at about +0.01 V.

In one embodiment, the mediator has a one electron redox wave at about −0.22 V.

The potentials are expressed with respect to the normal hydrogen electrode (NHE). The redox wave may be determined by cyclic voltammetry, using a glassy carbon electrode, for example, as described herein.

In one embodiment, the mediator is used in an electrolyte having a pH that is at most 6, at most 5, at most 4, at most 3, or at most 2.

In one embodiment, the mediator is used in an electrolyte having a pH that is at least 0.1, at least 0.2 or at least 0.3.

In one embodiment, the mediator is used in an electrolyte having a pH that is in a range having upper and lower values selected from the values above.

In one embodiment, the mediator is a buffering agent. Thus, in use, the mediator is suitable for accepting and donating protons. In use, the mediator may substantially maintain the pH of the electrolyte solution during an electrochemical reaction. As noted above, the mediators described herein can function as a donor, acceptor and store for both electrons and protons. The present inventors have established that the hydrogen and/or oxygen evolution reactions are optionally performed under conditions where the electrolyte is buffered, for example by the mediator itself.

The mediator may be coloured i.e. the mediator may absorb light in the visible spectrum.

In one embodiment, the reduced and oxidised forms of the mediator are different colours. Such a change is a useful feature of certain mediators, such as polyoxometallates. As the amount of oxidised or reduced mediator increases, the colour of the electrolyte may change. The changes in electrolyte colour may be a useful indicator of reaction progress, and mediator conversion with the electrolyte. Furthermore, in some embodiments of the invention, the mediator is retained by a membrane to a working electrode part of the electrolyte space. If there is deterioration in the integrity of the membrane, such that the mediator is able to move into the counter electrode region of the electrolyte space, this may be readily detected by the operator as a change in, or the appearance of, colour in the electrolyte within the counter electrode region.

In one embodiment, the mediator has at least 10 atoms, at least 15 atoms or at least 20 atoms.

In one embodiment, the mediator has at least 3 oxygen atoms, at least 4 oxygen atoms, or at least five oxygen atoms.

In one embodiment, the mediator has a molecular weight of at least 100, at least 150, at least 200, or at least 500.

In one embodiment, the mediator does not contain a Fe atom.

In one embodiment, the mediator does not contain an I atom.

As noted above, the mediator may be a polyoxometallate.

In one embodiment, the polyoxometallate comprises at least 2, 3, 6, 7, 12, 18, 24, 30 or 132 metal atoms.

In one embodiment, the polyoxometallate comprises 2, 3, 6, 7, 12, 18, 24, 30 or 132 metal atoms.

In one embodiment, the polyoxometallate comprises 6, 7, 12, 18, 30 or 132 metal atoms.

The number of oxygen atoms is determined by the number of metal atoms present in the polyoxometallate, and the particular structure adopted by the cluster.

In one embodiment, the polyoxometallate has 12 metal atoms. In this embodiment, the cluster may comprise 40 oxygen atoms.

In one embodiment, the polyoxometallate has 18 metal atoms. In this embodiment, the cluster may comprise 54 oxygen atoms.

The polyoxometallate may have a major metal atom component and one or more further heteroatom components selected from P, Si, S, Ge, W, V, Mo, Mn, Se, Te, As, Sb, Sn, and Ti.

The polyoxometallate may have a major metal atom component and one or more further heteroatom components selected from W, V, Mo, Nb, Ti, V, Cr, Mn, Fe, Co, Ni, Cu, Zn, Sn, Pb, Al, and Hg.

In one embodiment, the metal atoms in the polyoxometallate are selected from the group consisting of W, Mo, V and Nb, and combinations thereof.

In one embodiment the metal atoms in the polyoxometallate are selected from the group consisting of Mo and V, and combinations thereof.

In one embodiment the metal atoms in the polyoxometallate are Mo atoms.

In addition to any of the W, Mo, V and/or Nb atoms present, the polyoxometallate may further comprise Ti, V, Cr, Mn, Fe, Co, Ni, Cu, and/or Zn.

In addition to any of the W, Mo, V and/or Nb atoms present, the polyoxometallate may further comprise Sn, Pb, Al, and/or Hg.

Polyoxometallates of the type described above are particularly favoured in view of the fact that they consist of earth-abundant elements.

In one embodiment, the polyoxometallate is of formula {Hₘ[M₁₂O₄₀X]}ⁿ⁻ where m is 0, 1, 2, 3, 4, 5 or 6 as appropriate, M is a metal, such as Mo, W or V, or mixtures thereof, X is P or Si, n is an integer, for example from 1 to 6. Where n is not 0, one or more suitable counter ions may be provided, such as a metal cation from Group 1 or Group 2, for example Na⁺, K⁺, and Mg²⁺.

In one embodiment, the polyoxometallate is of formula Hₘ[M₁₂O₄₀X] where m is 3, 4, 5 or 6 as appropriate, M is a metal, such as Mo, W or V, or mixtures thereof, and X is P or Si.

In one embodiment, the polyoxometallate is of formula [M₁₂O₄₀X]ⁿ⁻ where M is a metal, such as Mo, W or V, or mixtures thereof, X is P or S, and n is 3, 4, 5 or 6 as appropriate. One or more suitable counter ions may be provided, such as a metal cation from Group 1 or Group 2, for example Na⁺, K⁺, and Mg²⁺.

The metal atoms in the polyoxometallate may be the same or different. Typically, the metal atoms are the same.

In one embodiment, the mediator is HₘM₁₂O₄₀X, such as H₄W₁₂O₄₀Si, and the reduced form is H₆W₁₂O₄₀Si ^{or H}₅W₁₂O₄₀Si, or mixtures thereof.

In one embodiment, the reduced form of the mediator is H₆W₁₂O₄₀Si, and the mediator is H₄W₁₂O₄₀Si or H₅W₁₂O₄₀Si, or mixtures thereof.

Silicotungstic acid (H₄W₁₂O₄₀Si) is well-suited to the role of a mediator for several reasons: it is highly soluble in water at room temperature, at up to 0.5 M (allowing high concentrations to be accessed), it is commercially available in a form where the only counter-cation is H⁺, it contains no easily oxidised moieties which might decompose during electrolysis, it accepts charge-balancing protons when it is reduced (hence it should buffer the solution pH during water splitting), it is shown to be compositionally stable within the pH range studied, and the 2-electron reduced form, H₆W₁₂O₄₀Si does not spontaneously re-oxidise under an inert atmosphere at room temperature i.e. both the oxidised and first reduced forms should be stable under ambient conditions when under an inert atmosphere.

In one embodiment, the mediator is an organic compound, such as a compound having functional groups, such as hydroxyl, amino, carboxy, sulphate, and poly(alkyleneglycol) groups, which may solubilise the compound in an aqueous electrolyte. An example of an organic compound used as a mediator is a compound having a quinone group (a quinone compound). The reduced form of the quinone compound is a compound having a 1,4-dihydrobenzene or a 1,2-dihydrobenzene group. Quinone compounds are described and exemplified in WO 2013/068754.

The present inventors have determined that mediators, such as polyoxometallates, for use in the present invention do not cause degradation of the membrane. The inventors have established that the membrane remains intact after at least five weeks' exposure to a polyoxometallate in an aqueous electrolyte solution.

The oxidation and reduction of polyoxometallates may be accompanied by a colour change. The change in colour is associated with the appearance/disappearance of absorption bands associated with for example, intervalance charge transfer between metals of different oxidation sates within a cluster.

Polyoxometallates are available commercially or may be prepared as required using standard techniques, such as those described by G. A. Tsigdinos, Ind. Eng. Chem., Prod. Res. Develop. 13, 267 (1974). The preparation, identification and use of other polyoxometallate structures are usefully reviewed in Long et al.

### Catalyst

In the methods of the invention a catalyst is contacted with a reduced mediator, thereby to generate hydrogen. The catalyst refers to a material that is provided outwith an electrochemical cell, and the catalyst participates in the non-electrochemical generation of hydrogen.

The catalyst is not an electrode. Thus, a voltage is not applied to the catalyst when it is contacted with the reduced mediator. In one embodiment, the catalyst is not provided in an electrochemical cell. Thus, once the reduced mediator is generated in the electrochemical cell it is removed from the cell, and is then subsequently contacted with the catalyst. Thus, the generation of hydrogen is separated from the generation of oxygen in the electrochemical cell.

Typically the catalyst is a metal catalyst, which may be provided on a support, such as a carbon support. The catalyst may be a transition metal catalyst.

In one embodiment, the catalyst is or comprises one or more metals selected from Groups 3 to 12, such as Groups 6 to 10, and optionally where such metals may further be selected from Periods 4, 5 and 6 in the selected Groups.

In one embodiment, the catalyst is or comprises one or more metals selected from the group consisting of Pt, Rh, Pd, Mo and Ni. The metal may be neutral or charged.

In one embodiment, the catalyst is provided on carbon.

In one embodiment, the metal is provided on carbon in an amount of at most 10, at most 5, at most 3, at most 2 or at most 1 wt %.

The catalyst may be added to the reduced mediator that is withdrawn from the electrochemical cell. Thus, the reduced mediator may be provided in an aqueous electrolyser solution.

The catalyst may be in a form to maximise the surface contact area with the mediator. Thus, the catalyst may be provided as a powder or a mesh, for example.

The catalyst may be provided in an atmosphere that is substantially free of oxygen. The catalyst may be provided in a nitrogen or argon atmosphere.

The catalyst may simply be contacted with the reduced mediator, thereby to generate hydrogen. The mixture of the catalyst and the reduced mediator may be agitated, such as stirred.

In one embodiment, the catalyst may be immobilised, and the reduced mediator may be permitted to flow across the immobilised catalyst. The contact between the catalyst and the reduced mediator may be maximised by permitting the reduced mediator to flow along a flow path that is provided with catalyst along its length.

The catalyst may be used as part of a batch or flow system, as described previously.

### Apparatus

The present invention also provides an apparatus for use in the methods of the invention.

The electrochemical cell may be provided as part of an apparatus, where the apparatus is a vessel for holding the components of the electrochemical cell. Thus, the apparatus may have walls and a base for holding the electrolyte comprising the mediator and/or reduced mediator.

The apparatus may comprise an array of a plurality of electrochemical cells. The electrochemical cells may be arranged in a stack, for example.

The portion of the apparatus that provides the vessel for the electrochemical cell may be resistant to acidic degradation. The vessel materials may differ from the catalyst.

The apparatus may further comprise the power supply and analytic equipment discussed in relation to the electrochemical cell.

The apparatus may comprise receptacles for holding gases generated in the method of the inventions, such as hydrogen and oxygen.

The apparatus may be a flow apparatus, where the electrochemical cell is fluidly connected to a reaction vessel. The reaction vessel may be provided downstream of the electrochemical cell. Reduced mediator generated in the electrochemical cell is permitted to flow to the reaction vessel, which is provided a catalyst.

The apparatus may be adapted to allow fluid to pass from the reaction vessel to the electrochemical cell, thereby to allow for recycling of material within the system. Thus, an oxidised form of the reduced mediator may be generated in the reaction vessel (with concomitant generation of hydrogen) and the oxidised form of the reduced mediator may be permitted to flow to the electrochemical cell.

The apparatus may be provided with pumps to control the movement of fluids through the apparatus. The apparatus may be provided with pumps to alter the pressure within the apparatus, such as the pressure in the electrochemical cell and/or the reaction vessel. A pump may be used to compress a gas that is generated from the electrochemical cell and/or the reaction vessel.

The electrochemical cell and/or the reaction vessel may each be fluidly connected to (separate) receptacles for holding gases. Thus, gas generated in the electrochemical cell and/or the reaction vessel may be permitted to flow into the receptacles.

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### Experimental

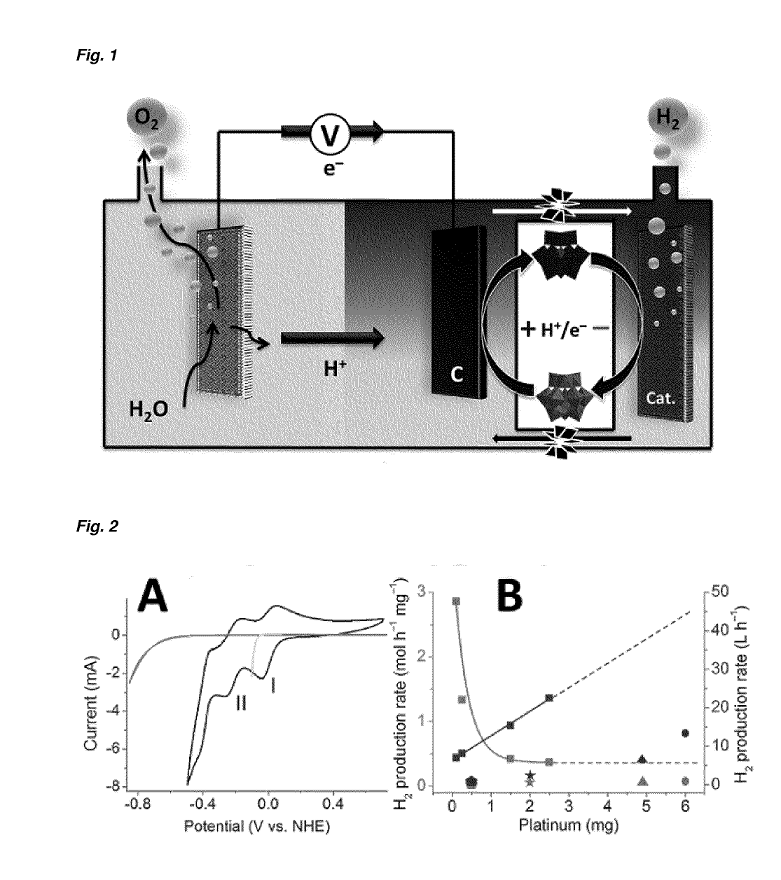

A system for generating hydrogen and oxygen from water is shown schematically in FIG. 1. At the anode (left), water is split into O₂, protons and electrons whilst the mediator is reversibly reduced and protonated at the cathode in preference to direct production of H₂. The reduced mediator, shown as H₆[SiW₁₂O₄₀] (dark shading), is then transferred to a separate chamber for hydrogen evolution over a suitable catalyst, and without additional energy input after two-electron reduction of the mediator, to H₆[SiW₁₂O₄₀]

A working system is described in further detail below.

### General

All solvents were purchased from Sigma Aldrich. 0.18 mm-thick Nafion N-117 membrane was purchased from Alfa Aesar. All chemical reagents and solvents were used as purchased. Pd foil (0.1 mm thickness, 99.9% metals basis), Au foil (0.025 mm, 99.95%), Cu foil (0.05 mm, 99.8%), W (0.1 mm, 99.95%), Ag foil (0.1 mm, 99.998%), Pt gauze (52 mesh woven from 0.1 mm diameter wire, 99.9%), Pt foil (0.1 mm, 99.99%), Carbon felt (3.18 mm, 99.0%), Pd on activated carbon (Pd/C, 10 wt % loading), Pt on activated carbon (Pt/C 5 wt %, 3 wt %, 1 wt %), molybdenum(IV) sulfide (MoS₂, 99%) were all purchased from Alfa Aesar. Silicotungstic acid (H₄[SiW₁₂O₄₀]), nickel phosphide (Ni2P, −100 mesh, 98%), rhodium on activated carbon (Rh/C, 5 wt % loading) were purchased from Sigma-Aldrich. All electrolyte solutions were prepared with Type 1 purified water (18 MΩ-cm resistivity). pH determinations were made with a Hanna HI 9124 waterproof pH meter. Unless otherwise stated, all solutions of reduced silicotungstic acid were kept under an argon atmosphere.

### Electrochemical Methods

Three-electrode electrochemical studies were performed using a CH Instruments CHI760D or a CH Instruments CHI600. Unless stated otherwise, three-electrode electrochemistry was performed using a 3 mm diameter glassy carbon disc working electrode (Princeton Applied Research) with a large area Pt-mesh counter electrode and a 3 M Ag/AgCl reference electrode (BASi) at room temperature and pressure. Solutions for cyclic voltammetry were quiescent, whilst both compartments of the H-cells were stirred during bulk electrolysis. Stirred three-electrode current-potential curves were performed using a 2 mm diameter Pt disc working electrode (Princeton Applied Research) or a 3 mm diameter glassy carbon working electrode (Princeton Applied Research) with a large area Pt mesh counter electrode and a Ag/AgCl reference electrode (BASi) at room temperature and pressure, with iR compensation enabled.

Linear sweep experiments were conducted under Ar at a sweep rate of 3 mV s⁻. Solutions were stirred. Each experiment was repeated at least three times and the results averaged. Potentials were converted to NHE potentials by using E_{(NHE)}=E_{(3 M Ag/AgCl)}+0.207 V. The compartments of the H-cells were separated by a piece of 0.18 mm thick Nafion membrane, with this membrane being held in place by judicious application of Araldite epoxy glue (Bostik Findley, Ltd., UK).

The applied voltages were corrected for the ohmic resistance of the cells (the iR drop), to give an effective voltage (V_{effective}) for the potential-current curves according to the formula: (34)

V_{effective}=V_{applied}−iR

where i is the current flowing through the cell and R is the resistance of the cell. Cell resistances were measured by the iR test function available on the potentiostats. The error associated with these iR-corrected curves is dominated by the error associated with gauging the resistance of the solution, where values were found to vary over a range of R_{measured}±5%.
General Procedure for Electrochemical Reduction of H₄[SiW₁₂O₄₀]

The redox mediator silicotungstic acid (H₄[SiW₁₂O₄₀]) was used as an exemplary mediator, the cyclic voltammogram (CV) of which on a glassy carbon electrode in aqueous solution is shown in FIG. 2A (black line). H₄[SiW₁₂O₄₀] was chosen for investigation on account of its high solubility in water (up to 0.5 M), in which solvent it is a strong acid (Keita et al.). H₄[SiW₁₂O₄₀] has reversible 1-electron redox waves centered at +0.01 V (wave I) and −0.22 V (wave II, all potentials are vs. Normal Hydrogen Electrode (NHE). Also shown in FIG. 2A are reductive scans taken at a similar pH in the absence of H₄[SiW₁₂O₄₀] on carbon and platinum electrodes (red and green lines respectively). Given that the onset of hydrogen evolution on platinum occurs at essentially the same potential as the first reduction of H₄[SiW₁₂O₄₀] but that hydrogen evolution on carbon is not appreciable above −0.6 V, it was hypothesized that that reduction of H₄[SiW₁₂O₄₀] at a carbon electrode at potentials slightly more positive than −0.6 V would give the two-electron reduced form (H₆[SiW₁₂O₄₀]) without any competing hydrogen evolution. If H₆[SiW₁₂O₄₀] were then exposed to platinum it should spontaneously evolve hydrogen until equilibrium between H₂ and reduced mediator was reached, which FIG. 2A suggests will correspond to a mixture of H₄[SiW₁₂O₄₀] and the 1-electron reduced form, H₅[SiW₁₂O₄₀].

An air-tight electrolysis cell was constructed with a Pt mesh or carbon felt anode (for water oxidation) and a carbon felt cathode (for H₄[SiW₁₂O₄₀] reduction). Reduction of the mediator and concomitant water oxidation were performed and the composition of the gases in the separated headspaces monitored by gas chromatographic headspace analysis (GCHA). Full Faradaic efficiency for O₂ evolution could be observed (using Pt anodes), whilst complete 2-electron reduction of the mediator could be achieved with only trace H₂ being evolved, see FIGS. 10 and 11. This 2-electron reduced H₆[SiW₁₂O₄₀] could then be stored without significant spontaneous H₂ evolution (<0.002% loss of H₂ per hour, see FIG. 11). Taken together, these data suggest that oxygen evolution and hydrogen evolution can be effectively decoupled from each other using H₄[SiW₁₂O₄₀], potentially allowing the O₂ produced during electrolysis to be vented to the atmosphere without the need for additional hydrogen removal processes.

In a typical experiment, 20 mL of a 0.5 M solution of H₄[SiW₁₂O₄₀] (28.80 g) in water (final pH=0.5) was placed into one compartment of a two-compartment H-cell. H-cells were cleaned with aqua regia (by soaking overnight) and fitted with a fresh Nafion membrane prior to use, in order to remove any trace Pt contaminants. When cells that were contaminated with traces of Pt were used, much higher levels of hydrogen were evolved during reduction of H₄[SiW₁₂O₄₀] to H₆[SiW₁₂O₄₀]. At this concentration (0.5 M), the mediator readily dissolves at room temperature (at higher concentrations (e.g. 0.7 M), precipitation occurred after solutions were left standing overnight, hence the maximum concentration used was 0.5 M.). This mediator compartment was equipped with a large area carbon felt working electrode and an Ag/AgCl reference electrode. The other compartment of the cell was filled with 1 M H₃PO₄ (pH=1.0) and equipped with either a large area platinum mesh counter electrode or a large area carbon felt working electrode.

Results with both counter electrodes were comparable, although use of a Pt counter electrode tended to lead to slightly earlier onset of hydrogen evolution, possibly as a result of Pt species leaching into solution and reaching the working electrode compartment. Phosphoric acid at 1 M was chosen for the electrolyte in the gas-evolving side of the H-cells in order to maintain a pH and ionic concentration similar to that on the mediator-containing side of the cells. Phosphate is also comparatively stable to both oxidation and reduction. The two chambers of the H-cell were separated by a Nafion membrane, so that protons could travel freely between compartments, but the movement of anions was attenuated. The H_{4[}SiW₁₂O₄₀] solution was bubbled with argon, stirred vigorously and kept under an argon atmosphere throughout the experiment.

To fully reduce the H₄[SiW₁₂O₄₀] solution by two electrons (forming blue solutions), a potential of 0.56 V vs. Ag/AgCl was set on the working electrode and 1931 C of charge was passed at this potential. If kept properly degassed and free of Pt in the mediator compartment, parasitic losses as hydrogen evolution are minimal and reaction of reduced mediator with oxygen can be eliminated. Passage of greater than 1931 C into these solutions was noted to produce brown solutions that could only be fully re-oxidized by applying a potential of at least +1.0 V (vs. Ag/AgCl), which is consistent with the formation of tungstate species that are more reduced than two electrons, analogous to those previously observed for metatungstate (Launay et al.; Smith et al.).

### Gas Chromatography

Electrochemistry for gas chromatography headspace analysis (GCHA) was conducted in airtight H-cells in a 3-electrode configuration. The GC analysis was performed using an Agilent Technologies 7890A GC system by direct injection of gas from the H-cells into the GC using a gas-tight syringe.

The column used was a 30 metre-long 0.320 mm widebore HP-molesieve column (Agilent). The GC oven temperature was set to 27° C. and the carrier gas was Ar. The front inlet was set to 100° C. The GC system was calibrated for O₂ and H₂ using certified standards of these gases at a range of volume % in argon (0.5%-10%) supplied by CK Gas Products Limited (UK). Linear fits of volume % vs. peak area were obtained, which allowed peak areas to be converted into volume % of O₂ and H₂ in the H-cell headspace. A small air leak into the cell introduced during sampling was corrected for by calibrating the amount of O₂ and N₂ in air and then applying appropriate corrections for these based on the amount of N₂ observed in the chromatographs. Total H-cell/GC system headspaces were calculated by filling the cells with water at room temperature. Typical headspaces were on the order of 35 to 40 mL.

### Faradaic Efficiency for Oxygen and Hydrogen Production

A 0.5 M solution of H₄[SiW₁₂O₄₀] in water (pH=0.5, 20 mL) was placed into one compartment of a two-compartment H-cell with a Pt counter electrode under Ar. The other compartment of the cell was filled with 1 M H₃PO₄ (pH=1.0). The H₄[SiW₁₂O₄₀] solution was then reduced at a potential of −0.56 V vs. Ag/AgCl to form a 50:50 mix of H₄[SiW₁₂O₄₀] and its corresponding 1-electron reduced form H₅[SiW₁₂O₄₀] (requiring the passage of half the charge required to reduce this sample by one electron, or 480 C). Both compartments of the cell were then flushed vigorously with argon for several minutes and re-sealed. The so-prepared mediator solution was then either electrochemically reduced by a further 15 C (with corresponding oxygen evolution in the H₃PO₄ compartment) or re-oxidized by 20 C (with corresponding hydrogen evolution in the H₃PO₄ compartment). Between each run the whole apparatus was vigorously flushed with argon.

Mediator reduction at one electrode and water oxidation at the other gave oxygen (but no hydrogen was detected in either of the headspaces). Similarly, H₅[SiW₁₂O₄₀] oxidation at one electrode and reduction of protons at the other gave hydrogen and essentially no oxygen (vide infra) in either of the headspaces within the detection limits of the GC system, which were gauged to be ±0.02% H₂ in the headspace and ±0.08% O₂ in the headspace. Charges passed were converted into expected volume % of hydrogen in the headspace by converting charges to an expected number of moles of H₂ (by dividing by 2F, where F is the Faraday constant), and then taking the volume of 1 mole of an ideal gas at room temperature and pressure to be 24.465 L.

Faradaic efficiencies were then calculated by taking the ratio of gas volume % based on the charge passed to the gas volume % measured by GC. All H₂ determinations were performed at least three times, and average Faradaic efficiencies were 95%±7% for a Pt cathode (performing the hydrogen evolution reaction, see FIG. 10) in combination with a carbon anode (oxidizing H₅[SiW₁₂O₄₀]) in a three-electrode set-up. The amount of oxygen in each measurement was corrected for air leaks by comparison with the amount of nitrogen (from the air) in each sample. For oxygen production, charges passed were converted into expected volume % in the headspace by converting charges to an expected number of moles of O₂ (by dividing by 4F, where F is the Faraday constant), and then taking the volume of 1 mole of an ideal gas at room temperature and pressure to be 24.465 L.

Faradaic efficiencies were then calculated by taking the ratio of gas volume % based on the charge passed to the gas volume % measured by GC. O₂ determinations were performed at least three times, and average Faradaic efficiencies were 100%±5% for a Pt anode (performing the oxygen evolution reaction, see FIG. 10) in combination with a carbon cathode (reducing H₄[SiW₁₂O₄₀]) in a three-electrode set-up. The single biggest source of error was the estimation of the cell headspace (±1 mL).

### Trace Hydrogen Evolution

An H-cell was equipped with 20 mL of a 0.2 M solution of H₄[SiW₁₂O₄₀] in water (pH=0.7). The other compartment of the cell was filled with 1 M H₃PO₄ (pH=1.0). The mediator-containing compartment of the cell was flushed vigorously with argon before it was sealed, while the 1 M H₃PO₄-containing compartment remained unsealed and continuously bubbled with Ar. The H₄[SiW₁₂O₄₀] solution was then reduced by two electrons at potential of −0.52 V vs. Ag/AgCl, by passing 800 C of charge at this potential. The headspace of the H₄[SiW₁₂O₄₀]-containing compartment was analyzed by GCHA. During the 1-electron reduction step (the first 400 C) no hydrogen was detected in the headspace, whilst during the reduction of H₅[SiW₁₂O₄₀] to H₆[SiW₁₂O₄₀] (the second 400 C of charge) trace amounts of hydrogen could be detected, corresponding to less than 0.03% of the total possible amount of hydrogen, based on the total charge passed (800 C) and the number of moles of hydrogen this could in theory generate upon complete re-oxidation to H₄[SiW₁₂O₄₀] (see FIG. 11). Significantly more H₂ evolution was observed when using cells that had not been cleaned with aqua regia to remove platinum contaminants before use.

A series of 50 mL round bottom flasks (RBFs) were equipped with a given metal foil catalyst (10 mm×10 mm in size) and sealed with a septum. Each RBF was then thoroughly flushed with argon. 4 mL of dark blue, two electron reduced H₆[SiW₁₂O₄₀] was then injected via syringe into these RBFs containing the various metal foil catalysts (Pt, Pd, Ag, Au, Cu, W and no foil as a control). Alternatively, 2 mL of H₆[SiW₁₂O₄₀] were added to MoS₂ (50 mg, powder) or Ni₂P (50 mg, powder). Each sample was agitated for three days and GCHA was performed to analyze the headspace contents. Au, Ag, Pd and Cu all showed only very modest catalytic activity compared to the control without any additive, whilst Pt foil displayed the highest activity of the foils (see FIG. 4). For the powdered samples, both MoS₂ and Ni₂P were found to be effective hydrogen evolution catalysts from solutions of H₆[SiW₁₂O₄₀] (see FIG. 4).

Hydrogen Evolution from H₆[SiW₁₂O₄₀]

The 2-electron reduced mediator was removed from the electrolysis cell and introduced into sealed reaction flasks under an atmosphere of Ar. Addition of various metal foils to this solution catalyzed hydrogen evolution, with Pt exhibiting the best performance (see FIG. 4). Powdered samples of MoS₂ (Karunadasa et al.; Merki et al.) and Ni₂P (Popczun et al.) were also found to be effective catalysts for H₂ evolution from H₆[SiW₁₂O₄₀] (FIG. 4). However, by far the greatest rate of hydrogen evolution was found when using precious metal catalysts supported on carbon. FIG. 2B shows that per milligram of Pt used, the rate of hydrogen production from H₆[SiW₁₂O₄₀] exceeds the rate of hydrogen evolution possible using a state-of-the-art PEME by a factor of 30 (red data). This more effective use of the precious metal hydrogen evolution catalyst could be a result of the better dispersion of catalyst possible when it is not confined to an electrode.

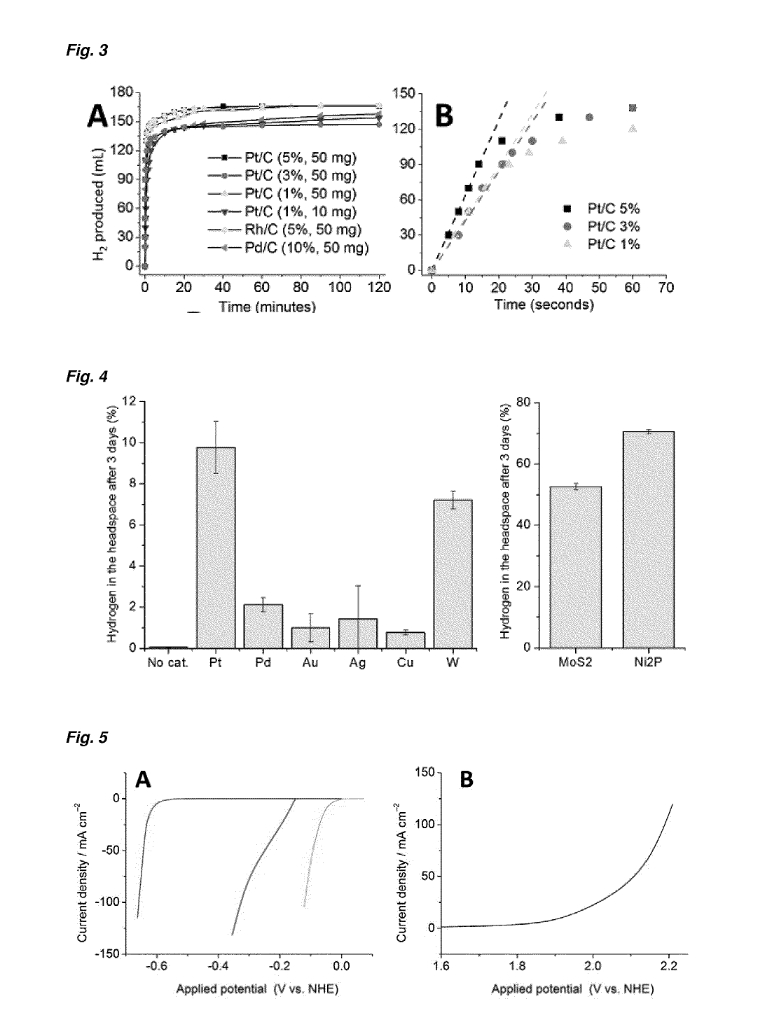

Rh/C (5 wt. % loading), Pd/C (10 wt. % loading) and Pt/C (various amounts and loadings) were tested for catalytic hydrogen evolution with H₆[SiW₁₂O₄₀] (see FIG. 3). 20 mL of a 0.5 M solution of H₆[SiW₁₂O₄₀] were prepared by electrochemical reduction of H₆[SiW₁₂O₄₀] according to the procedure given in section SI-3, a process that required 20 mmol of electrons, equating to the passage of 1931 C of charge. The theoretical amount of hydrogen that could be evolved in a complete 2 electron re-oxidation of H₆[SiW₁₂O₄₀] by protons is therefore 244.7 mL at 25° C. (as 10 mmols of H₂ would be liberated). If only a 1-electron oxidation by protons occurred, then only half this amount of hydrogen would be produced (122.4 mL) and the resulting mediator solution would remain in the 1-electron reduced form, H₅[SiW₁₂O₄₀].

The 2-electron reduced mediator was reacted with the various catalysts as follows. An RBF with Schlenk-tap was equipped with stirrer bar and various amounts of a given catalyst. Via a pressure-equalizing dropping funnel, the freshly produced H₆[SiW₁₂O₄₀] was added to the catalyst under Ar and stirred vigorously. The evolving gas was captured in a measuring cylinder filled with water, connected to the RBF via tubing and the Schlenk-tap.

GCHA of hydrogen evolved from H₆[SiW₁₂O₄₀] in the presence of catalysts supported on carbon revealed no electrolysis-derived O₂ to be present in this H₂ within the limits of detection of the gas chromatograph.

The kinetics of hydrogen evolution from solutions of H₆[SiW₁₂O₄₀] as a function of time and catalyst are examined in FIG. 3A. Based on the volume of mediator solution used in these experiments, full conversion of 2-electron reduced H₆[SiW₁₂O₄₀] to 1-electron reduced H₅[SiW₁₂O₄₀] would be expected to liberate 122.4 mL H₂, whilst complete reversion to H₄[SiW₁₂O₄₀] would release 244.7 mL H₂. In practice, somewhat more than 122.4 mL of hydrogen were liberated in under 30 minutes with all the catalysts examined in FIG. 3A, suggesting complete and rapid transformation of H₆[SiW₁₂O₄₀] to H₅[SiW₁₂O₄₀], followed by limited further conversion (10-36%) of H₅[SiW₁₂O₄₀] to H₄[SiW₁₂O₄₀] under these conditions.

Initial rates were then extrapolated to rates of hydrogen produced per mg of precious metal per hour (see Table 1 and Table 2), giving a maximum rate of 2861 mmol H₂ mg⁻¹h⁻¹ when using low loadings of Pt/C. The rate of hydrogen evolution decays from the initial value in FIG. 3B on account of the process H₆[SiW₁₂O₄₀]→H₅[SiW₁₂O₄₀] being 80% complete within 30 seconds for all the Pt/C loadings shown. Hence in a continuous flow system, it should be possible to achieve rates very similar to the initial rate measured here for as long as the flow of H₆[SiW₁₂O₄₀] is maintained (the mediator could then be recycled to the cathode for recharging). Table 1 compares the rate of H₂ production by the mediator-based system with that achieved by a selection of state-of-the-art PEMEs from the recent literature.

TABLE 1
Comparison of the rate of hydrogen production possible with
silicotungstic acid-mediated electrolysis and a selection of
leading PEMEs from the current literature.
Literature values are based on the highest rate
of H₂ production reported in those works.

| | | | | H₂ | |
|---|---|---|---|---|---|
| | | | Total | production | |
| Hydrogen | Amount | | platinum | rate | |
| Evolution | of powder/ | | used | [mmol h⁻¹ | |
| catalyst | size of electrode | | [mg] | mg⁻¹] | Reference |
| Pt/C (0.5 mg | 9 × 100 | cm⁻² | 450 | 22 | Siracusano |
| of Pt cm⁻²) | | | | | et al. |
| Pt/C (0.4 mg | 5 | cm⁻² | 2 | 47 | Mamaca |
| of Pt cm⁻²) | | | | | et al. |
| Pt/C (0.7 mg | 7 | cm⁻² | 4.9 | 53 | Millet |
| of Pt cm⁻²) | | | | | et al. |
| Pt/C (0.3 mg | 20 | cm⁻² | 6 | 93 | Xu |
| of Pt cm⁻²) | | | | | et al. |
| Pd/C 10% | 50 | mg | 5 | 143 | This work |
| Rh/C 5% | 50 | mg | 2.5 | 241 | This work |
| Pt/C 5% | 50 | mg | 2.5 | 368 | This work |
| Pt/C 3% | 50 | mg | 1.5 | 423 | This work |
| Pt/C 1% | 50 | mg | 0.5 | 1275 | This work |
| Pt/C 1% | 25 | mg | 0.25 | 1336 | This work |
| Pt/C 1% | 10 | mg | 0.1 | 2861 | This work |

TABLE 2
Comparison of rates of hydrogen evolution
from solutions of 0.5M H₆[SiW₁₂O₄₀]
with different catalysts and different catalyst
loadings. The hydrogen evolution rate was
taken from data shown in FIG. 3A (main text).
The conversion to a volume of gas was
based on room temperature and standard pressure
(1 mol of gas = 24.465 L at 25° C.). Rates of hydrogen
production quoted as “mmol h⁻¹ mg⁻¹” are based on
milligrams of precious metal used: Pd, Rh or Pt.

| | Amount | | | H₂ |
|---|---|---|---|---|
| | of | Precious | H₂ | evolution |
| | catalyst | metal | evolution | rate |
| | used | loading | rate | [mmol h⁻¹ |
| Catalyst | [mg] | [mg] | [L h⁻¹] | mg⁻¹] |
| Pd/C 10% | 50 | 5 | 17.5 | 143 |
| Rh/C 5% | 50 | 2.5 | 14.8 | 241 |
| Pt/C 5% | 50 | 2.5 | 22.5 | 368 |
| Pt/C 3% | 50 | 1.5 | 15.5 | 423 |
| Pt/C 1% | 50 | 0.5 | 15.6 | 1275 |
| Pt/C 1% | 25 | 0.25 | 8.2 | 1336 |
| Pt/C 1% | 10 | 0.1 | 7.0 | 2861 |

With PEMEs, the rate of H production is necessarily coupled to the rate of water oxidation occurring at the anode. In a mediated electrolysis cell, the rates of water oxidation and mediator reduction are coupled, but the rate of H production depends on the availability of the reduced mediator. This allows a mediated system to make more effective use of the H evolution catalyst, as illustrated by Table 1. The time required to reduce the mediator is not included in the calculations for Table 1: Only the rate of H production (and hence how long it would take to obtain all the H from the mediator for compression and/or storage) is considered.

The purity of the hydrogen that was produced by this silicotungstic acid-mediated method was examined. GCHA indicated that the level of electrolysis-derived oxygen in this hydrogen was below detectable limits (±0.08%). Moreover, if 10% oxygen were deliberately introduced into the headspace of the vessel containing H₆[SiW₁₂O₄₀], this extraneous O₂ was completely removed by reaction with H₆[SiW₁₂O₄₀] (% O₂ in the headspace was only 0.04% after 30 minutes), ultimately producing water and re-oxidized mediator, (Hiskia et al.) and further guaranteeing that the hydrogen evolved is oxygen-free (FIG. 7—see also below). This has obvious implications for electrolyzer safety as gaseous mixtures of H₂ and O₂ on the cathode side are now precluded by the reduced mediator's rapid reaction with oxygen. This reaction is spontaneous and does not require any precious metal-based recombination catalysts such as those often employed in PEMEs.

The primary mode of degradation of the perfluorinated membranes used in PEMEs is attack by reactive oxygen species (ROS).(Ghassemzadeh et al.) These ROS form in the presence of O₂, H₂ and precious metals (including the catalytic recombination layers that are designed to prevent mixtures of O₂ and H₂ forming in electrolysis product streams). Moreover, recombination of H₂ and O₂ is an exothermic process which causes local heating, damaging the membrane through mechanical means: this route is especially prevalent at platinum sites on the cathode (LaConti et al.; Aricò et al). The use of a mediator can help to mitigate against membrane degradation in three ways. Firstly, the amount of hydrogen produced in the electrolyzer itself is vastly diminished, removing the need to purify the oxygen product stream and preventing ROS formation on the anode side of the cell. Secondly, on the cathode side, the reduced mediator reacts rapidly with any O₂ present to produce water, and any peroxy species that do form will do so in bulk solution far from the membrane, and will themselves rapidly react with reduced mediator to form water (Hiskia et al.). Finally, the Pt catalyst is now isolated in a second chamber and is not in contact with the membrane, lessening local heating effects. Hence using a mediator could potentially allow increased lifetimes for the membranes used in such electrolyzers relative to the lifespan of similar membranes in PEMEs.

### Mediator Stability

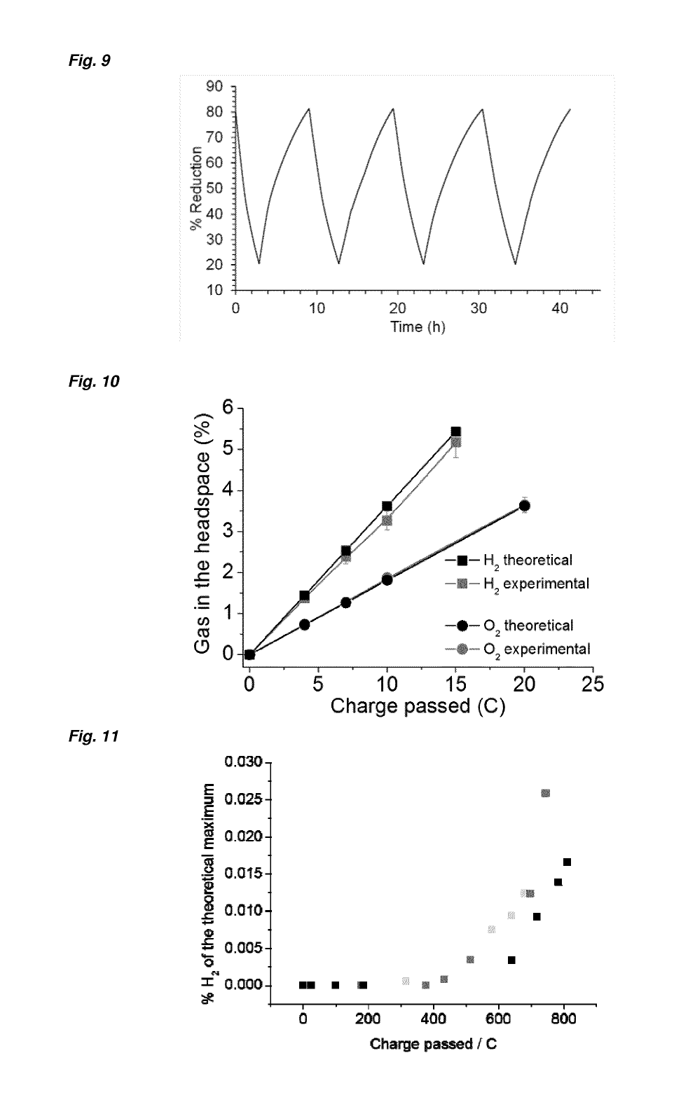

The stability of the mediator to several cycles of oxidation and reduction was probed both electrochemically (by comparing the charges passed in oxidizing the reducing the mediator over a series of cycles, and by comparing UV-vis spectra of fresh and cycled samples, and reduced samples that were re-oxidized by exposure to air. FIG. 8 shows that 98% of the charge passed in fully reducing the mediator by one electron could be retrieved by re-oxidation over nine full 1-electron reduction-oxidation cycles, with no apparent degradation of the mediator. FIG. 9 shows the stability of the mediator to four consecutive cycles of reduction to 80% of the maximum for full 2-electron reduction, followed by re-oxidation to 20% of this maximum. This experiment was designed to mimic the conditions under which the mediator would have to operate in a continuous flow system. The data in FIG. 9 suggest that there is no decay in the amount of charge that can be stored in the mediator (which would signal irreversible decomposition) within these bounds over the number of cycles probed. A sample of silicotungstic acid subjected to 20 consecutive 2-electron reduction and re-oxidation cycles has a UV-vis spectrum indistinguishable from a fresh sample of silicotungstic acid (data not shown). Taken together, these data suggest that the mediator is stable to redox cycling under these conditions and that H₄[SiW₁₂O₄₀] is suitable for use as a mediator in a continuous flow system.

Samples of H₄[SiW₁₂O₄₀] were dissolved in 20 mL 1 M H₃PO₄ (see below) and placed into one compartment of an H-cell with a Nafion separator. This compartment was also equipped with a carbon felt working electrode and an Ag/AgCl reference electrode. The second compartment was filled with 1 M H₃PO₄ and equipped with a carbon felt counter electrode.

H₄[SiW₁₂O₄₀]→H₅[SiW₁₂O₄₀]→H₄[SiW₁₂O₄₀]: 2.98 g of H₄[SiW₁₂O₄₀] were dissolved in 20 mL of 1 M H₃PO₄, such that 100 C would be required for complete 1-electron reduction of the mediator. 9 cycles of complete 1-electron reduction (at 0.36 V vs. Ag/AgCl) and subsequent 1-electron oxidation (at 0.00 V vs. Ag/AgCl) were performed. During the reduction processes (FIG. 8, squares) an average of 97.56 ±0.68 C were passed and during the re-oxidation processes (FIG. 8, circles) an average of 95.55 ±0.41 C were passed.

H₄[SiW₁₂O₄₀]→H₆[SiW₁₂O₄₀]→H₄[SiW₁₂O₄₀]:25 mL of a 0.2 M H₄[SiW₁₂O₄₀] solution in water were placed in one compartment of a 2 compartment H-cell. This compartment was equipped with a carbon felt working electrode and an Ag/AgCl reference electrode. The second compartment was filled with 1 M H₃PO₄ and equipped with a carbon felt counter electrode for gas evolution. Both compartments were constantly bubbled with argon and were covered with parafilm.

A full 2-electron reduction of this sample would require the passage of 964.9 C. The sample was initially reduced at −0.50 V vs. Ag/AgCl by 771.9 C, which corresponds to 80% of a full 2-electron reduction. The sample was then consecutively oxidized at 0.00 V vs. Ag/AgCl and reduced at −0.50 V vs. Ag/AgCl by 578.9 C per cycle to simulate cycling between reduction states corresponding to 80% and 20% of the full 2-electron reduction: see FIG. 11B.

### Electrochemical Efficiency

The efficiency of the electrochemical process to produce O₂ from water and H₆[SiW₁₂O₄₀] from H₄[SiW₁₂O₄₀] was calculated and compared to equivalent systems which would produce H₂ and O₂ directly by electrolysis (FIG. 5). In comparison to a system which uses a carbon cathode to reduce protons and a Pt anode to oxidize water, the mediated system was 16% more efficient, with an overall energy efficiency of 63%. A standard electrolysis system for direct O₂ and H₂ production from water where both electrodes are Pt was found to have an efficiency of 67% (which agrees well with the efficiency of room temperature PEMEs reported in the literature (Mamaca et al)). Hence, given the potential for lower loadings of precious metal and high initial purity of the product gases when using mediated electrolysis, it is believed that such systems will be competitive in terms of cost-efficiency metrics with PEMEs.

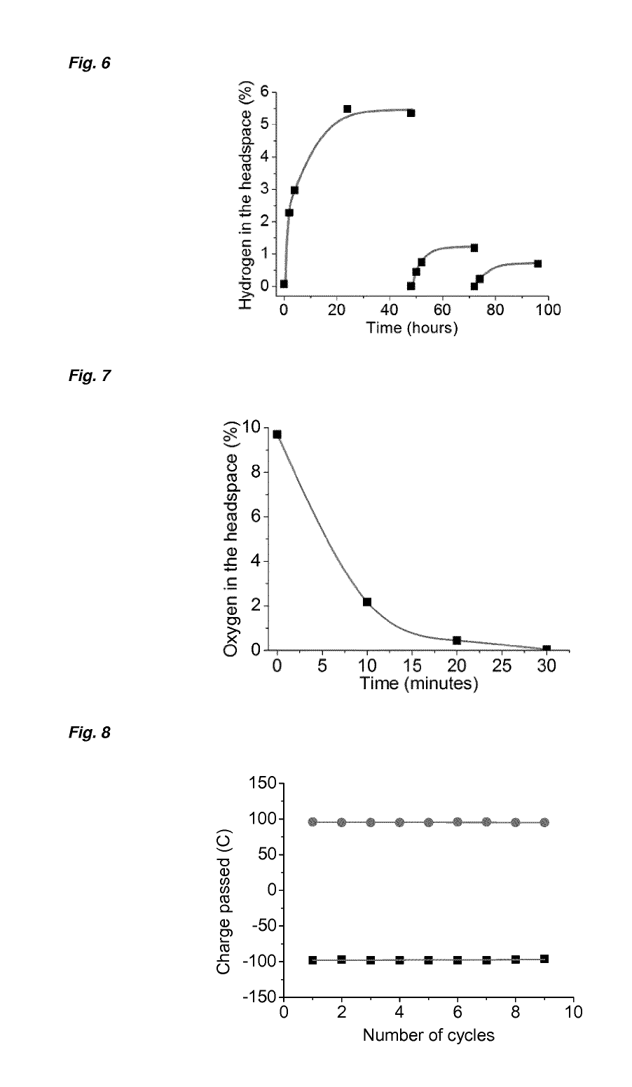

Starting from fully reduced H₆[SiW₁₂O₄₀], hydrogen evolution in the presence of a catalyst such as Pt/C is rapid, leading to the 1-electron reduced species H₅[SiW₁₂O₄₀]. This process can be reversed by electro-reducing H₅[SiW₁₂O₄₀] at a carbon cathode. Alternatively, starting from the fully oxidized species H₄[SiW₁₂O₄₀], the 1-electron reduced species can be accessed either by electrochemical reduction or by reaction with hydrogen in the presence of a suitable catalyst such as Pt/C. Likewise, if 1-electron reduced H₅[SiW₁₂O₄₀] is placed in a sealed reaction vessel under Ar in the presence of Pt/C, hydrogen evolves slowly into the headspace, as gauged by GCHA (see FIG. 6). This behavior implies that there exists an equilibrium between H₂ and H₄[SiW₁₂O₄₀] on one hand and the 1-electron reduced mediator (H₅[SiW₁₂O₄₀]) on the other in the presence of catalysts such as Pt/C.

Overall Faradaic efficiencies for the round trip process were gauged by fully reducing a sample of H₄[SiW₁₂O₄₀] to H₆[SiW₁₂O₄₀] with coulometry. Pt/C was then added to this H₆[SiW₁₂O₄₀] and hydrogen was evolved. At the cessation of spontaneous hydrogen evolution, an amount of H₂ corresponding to 68% of the charge passed in reducing H₄[SiW₁₂O₄₀] to H₆[SiW₁₂O₄₀] was obtained. In a cyclic system, any 1-electron reduced H₅[SiW₁₂O₄₀] could simply be returned to the electrolyzer for re-reduction to H₆[SiW₁₂O₄₀]. However in this case, once H₂ evolution had ceased, the Pt/C catalyst was removed by filtration under Ar, and the resulting Pt-free mediator solution was titrated with an Fe(III) source in order to oxidize all remaining H₅[SiW₁₂O₄₀] to colorless H₄[SiW₁₂O₄₀], and thus ascertain the amount of H₅[SiW₁₂O₄₀] still present at the cessation of hydrogen evolution. This value, when combined with the electrons already accounted for by the amount of H₂ evolved, gave a Faradaic yield in excess of 98% for the round trip H₄[SiW₁₂O₄₀]→H₆[SiW₁₂O₄₀]→H₄[SiW₁₂O₄₀].

The electrochemical efficiency of the H₄[SiW₁₂O₄₀]-mediated water splitting process was compared with the equivalent system in the absence of mediator by comparing the potentials required to give a specific current density for the various half-reactions as described below.

In a typical experiment for evaluating the potentials required to reduce H₄[SiW₁₂O₄₀] to H₅[SiW₁₂O₄₀] (data not shown), the counter electrode chamber of a two compartment H-cell was charged with 1 M H₃PO₄ (pH=1.0), whilst the working electrode chamber was filled with a 50:50 mix of 0.5 M H₄[SiW₁₂O₄₀] and its corresponding 1-electron reduced form H₅[SiW₁₂O₄₀] in water, at pH 0.5. This 50:50 mix was used to ensure that the reduction potential obtained was not unduly skewed by a high excess of either H₄[SiW₁₂O₄₀] or H₅[SiW₁₂O₄₀] in solution and would thus reflect a general condition. The working electrode was a 0.071 cm² area glassy carbon disc electrode and the counter electrode large surface area platinum mesh. The working electrode chamber was also equipped with an Ag/AgCl reference electrode. The two chambers of the H-cell were separated by a Nafion membrane. A similar experiment was also conducted to gauge the reduction potential required for 2-electron reduction of silicotungstic acid by using a mediator solution containing a 50:50 mix of 0.5 M H₅[SiW₁₂O₄₀] and the corresponding 2-electron reduced form H₆[SiW₁₂O₄₀] in water. Alternatively, to gauge the overpotentials required for water oxidation and proton reduction in the absence of the mediator, both chambers were filled with 1 M H₃PO₄ (pH=1.0). The water oxidation reaction was probed on a platinum disc working electrode (area=0.031 cm²), whilst the proton reduction overpotential was obtained on both glassy carbon and platinum electrodes.

All data were obtained by linear sweep voltammetry at a scan rate of 3 mA s⁻¹, the results of which are shown corrected for resistance in FIG. 5. Each experiment was conducted at least three times and the data averaged.

The data thus obtained were used to calculate the various reaction overpotential requirements and hence the efficiency of the system as follows. Taking a benchmark current density of 50 mAcm⁻², the production of H₆[SiW₁₂O₄₀] from H₅[SiW₁₂O₄₀] requires a potential of −0.25 V vs. NHE on a glassy carbon electrode (FIG. 5a, dark blue line). To achieve the same current density for water oxidation from 1 M H₃PO₄ on a Pt electrode requires +2.12 V vs. NHE (FIG. 5b). This means that in order to oxidize water and simultaneously reduce the mediator (to a state from which H₂ can be evolved spontaneously in the presence of the suitable catalyst), a total of (2.12+0.25=) 2.37 V must be applied across the cell to achieve a current density of 50 mAcm⁻². This system requires the use of one carbon and one Pt electrode.

This situation can be contrasted with those in which no mediator is used. To reduce protons to hydrogen in 1 M H₃PO₄ at a rate of 50 mA cm⁻² on a Pt electrode requires a potential of −0.09 V vs. NHE (FIG. 5a, green line). Thus to split water to hydrogen and oxygen on two Pt electrodes at a current density of 50 mA cm⁻² at pH 1 requires (2.12+0.09=) 2.21 V. On the other hand, to reduce protons to hydrogen in 1 M H₃PO₄ at a rate of 50 mA cm⁻² on a glassy carbon electrode requires a potential of −0.64 V vs. NHE (FIG. 5a, red line). Hence to oxidize water to oxygen and reduce protons to hydrogen in a system using one carbon and one Pt electrode (the equivalent cell to that used with the mediator), a total of (2.12+0.64=) 2.76 V must be applied across the cell to achieve a current density of 50 mA cm⁻².

The theoretical efficiency of the mediator-based cycle can then be compared to the mediator-less systems by comparing the voltages required to achieve this benchmark current density (Symes et al.). It was found that the mediator-driven system has 93% efficiency compared to a system that uses two precious metal electrodes to split water to give hydrogen and oxygen simultaneously. However, compared to the equivalent cell with one carbon and one Pt electrode, the system using the mediator is significantly more efficient, by around 16%.

In terms of an overall efficiency for hydrogen production, the cell utilizing 2 Pt electrodes and running at 50 mA cm⁻² consumes 0.1105 J of energy every second per cm² of electrode (0.05 A×2.21 V). A cell of size 100 cm² would pass 5 A every second (=5 C of charge) and (assuming a faradaic efficiency of 1), produce 1 mole of H₂ in 38594 seconds. The energy consumption for the production of 1 mole of H₂ by such an electrolyzer would therefore be 426.5 kJ (11.05 J per second for 38594 seconds). Based on the higher heat value (HHV, 286 kJ/mol) for the combustion of 1 mole H₂, an energy efficiency of 67% would be achieved (286 kJ/426.5 kJ). Compared to this, a mediator-based system using one carbon and one Pt electrode running at 50 mA cm⁻² consumes 0.1185 J of energy every second per cm² of electrode (0.05 A×2.37 V). Using the same calculation method used above, this means an energy consumption of 457.4 kJ/mol H₂, or an efficiency of 63%. Then again, a system using one carbon and one Pt electrode without any mediator would have an energy consumption of 532.6 kJ/mol H₂, or an efficiency of only 54%.

In terms of rate of production of the reduced mediator, H₆[SiW₁₂O₄₀], the maximum rate probed in this work was 130 mA cm⁻² (FIG. 5a). For the 1-electron reduction of H₅[SiW₁₂O₄₀] to H₆[SiW₁₂O₄₀] (FIG. 5a, blue line), this corresponds to a rate of production of the reduced mediator of 4.85 mmol h⁻¹ cm⁻², or for the complete 2-electron reduction of H₄[SiW₁₂O₄₀] to H₆[SiW₁₂O₄₀] a rate of 2.43 mmol h⁻¹ cm⁻². In comparison, a PEM electrolyzer that produces hydrogen and oxygen simultaneously can reach higher rates than this (albeit when higher voltages are applied): for example reference 26, reports a maximum rate of 28 mmol H₂ h⁻¹ cm⁻²). However, that does not necessarily mean that a mediated electrolyzer could not also match this rate if higher voltages were applied and/or if mass transport issues were reduced by optimized cell design or by continuous flow methods.

Equilibrium Between H₄[SiW₁₂O₄₀] and H₂ and H₅[SiW₁₂O₄₀]

In a typical experiment 10 mmol of H₄[SiW₁₂O₄₀] were reduced by 2 electrons (20 mmol of electrons, 1931 C) to give a 0.5 M solution of H₆[SiW₁₂O₄₀]. To this was added 50 mg Pt/C (5 wt. %) and spontaneous hydrogen evolution occurred as per FIG. 3. The amount of hydrogen evolved in this manner (166 mL at 25° C.=6.785 mmol H₂) accounted for 13.570 mmol of electrons (68% of the 20 mmols of electrons initially stored in the mediator), leaving 6.430 mmol of electrons (32% of the initial charge or a possible additional 78.65 mL of H₂) still to be extracted from the mediator before it would return to its fully oxidized state. After hydrogen evolution had ceased, the mediator solution was transferred together with the catalyst into a sealed RBF and the solution and headspace were thoroughly degassed with argon. After 48 hours an additional 5.7 mL of H₂ was detected in the RBF headspace by GCHA (accounting for 0.466 mmol of electrons, leaving 5.964 mmol of electrons still present as reduced mediator). The headspace was purged with Ar and after a further 24 h an additional 1.4 mL of hydrogen was detected in the headspace (accounting for 0.114 mmol of electrons, leaving 5.850 mmol of electrons still present as reduced mediator). The headspace was again purged with Ar and after a further 24 h an additional 0.99 mL of hydrogen formed in the headspace. Thus at the end of 96 h, 5.769 mmol of electrons were still present as reduced mediator, equating to 29% of the charge passed in initially reducing the mediator or an approximate ratio of H₄[SiW₁₂O₄₀]: H₅[SiW₁₂O₄₀] of 2:3. The data is shown in FIG. 6.

This equilibrium could also be probed by monitoring the uptake of hydrogen by the fully oxidized mediator H₄[SiW₁₂O₄₀] when in the presence of a suitable catalyst.

In short, three test tubes were connected in series and sealed under an atmosphere of pure hydrogen. Test tube three was filled with 50 mL of a saturated solution of Co(II) chloride (for color contrast). Test tube 1 was filled with a solution of 5.70 g H₄[SiW₁₂O₄₀] in 15 mL of water, and 25 mg of catalysts supported on carbon (either Rh/C 5%, Pd/C 10% or Pt/C 5%) were added with stirring. The initially grey mixture of H₄[SiW₁₂O₄₀] and catalyst turned dark blue immediately. By the resulting pressure drop in test tube 1, water was pulled from test tube 3 into test tube 2. A complete 1-electron reduction of 5.70 g of H₄[SiW₁₂O₄₀] to H₅[SiW₁₂O₄₀] would consume 2 mmol of electrons. Were these electrons all to be supplied by reduction of H₄[SiW₁₂O₄₀] by hydrogen, this would correspond to a consumption of 24.2 mL of hydrogen from the apparatus headspace (at 25° C. and 1 atm. pressure). In a typical experiment, liquid first appeared in tube 2 (from tube 3) after 3-5 minutes, with around 10 mL of colored water being transferred within the first 60 minutes after addition of catalyst. After this, the rate of transfer slowed noticeably, giving a total transfer of between 16 and 19 mL of solution (65-76% completion for the process H₄[SiW₁₂O₄₀]+½H₂→H₅[SiW₁₂O₄₀]). No reaction between H₄[SiW₁₂O₄₀] and hydrogen occurred in the absence of catalysts supported on carbon.

Reaction Between H₆[SiW₁₂O₄₀] and Oxygen

A 50 mL RBF was flushed with argon, then with 9.95% oxygen in argon. 20 mL of 0.5 M H₆[SiW₁₂O₄₀] prepared by electrochemical reduction of H₄[SiW₁₂O₄₀] according to section SI-3 was then added to this flask and GCHA was conducted at regular intervals. The RBF was shaken between the samplings by hand. GCHA analysis showed 9.67% oxygen in the headspace immediately after the addition of H₆[SiW₁₂O₄₀] to the flask, 2.18% after 10 minutes, 0.45% after 20 minutes and 0.04% after 30 minutes (see FIG. 7).

### Faradaic Efficiency for Regeneration

A 0.5 M solution of H₆[SiW₁₂O₄₀] (20 mL) was prepared electrochemically from H₄[SiW₁₂O₄₀] according to the general procedure given above. This required 1931 C of charge to be passed (20 mmol electrons). Upon complete reduction, this sample was mixed with 50 mg Pt/C (5 wt. %) and spontaneous hydrogen evolution monitored for 2 hours. Based on the yield of hydrogen and the initial charge passed in reducing the H₄[SiW₁₂O₄₀] to H₆[SiW₁₂O₄₀], the remaining charge stored in the mediator was then calculated, and was found to equate to 6.4 mmol of electrons stored in the mediator solution (13.6 mmol of electrons were consumed for spontaneous hydrogen evolution). The heterogeneous catalyst was then removed from the mediator solution under argon using a short column filled with celite. This filtered mediator solution was then titrated with a 0.5 M Fe³⁺ solution (0.25 M Fe₂(SO₄)₃ in 0.1 M H₂SO₄) until the dark blue coloration characteristic of all forms of the reduced mediator had disappeared and the solution had assumed the pale yellow color of the Fe₂(SO₄)₃ solution. The position of the Fe(II)/Fe(III) redox wave at this pH (˜0.5) is more than sufficient to oxidize the mediator to H₄[SiW₁₄O₄₀], but reduction to Fe(0) is not possible. This means that Fe(III) salts should act as one electron oxidants under the conditions used here. In the event, it was found that 12.2 mL of 0.25 M Fe₂(SO₄)₃ in 0.1 M H₂SO₄ were required for complete re-oxidation of the mediator, corresponding to 6.1 mmol of electrons. Together the amount of hydrogen already evolved from this solution, this accounts for >98% (13.6 mmol+6.1 mmol=19.7 mmol) of the 20 mmol of charge initially used to reduce the mediator solution.

### Electronic Spectra of Silicotungstic Acid

UV/vis spectra were recorded using an Avantes AvaSpec-2048L dip probe and an Ocean Optics DH-200 Halogen UV-vis-NIR light source. A spectrum was recorded of a freshly-prepared 25 mM solution of H₄[SiW₁₂O₄₀]. The solution was reduced and re-oxidized by 2 electrons under Ar 20 times, and then a spectrum of this 20-times-cycled re-oxidized H₄[SiW₁₂O₄₀] was recorded. A difference spectrum obtained by subtracting the re-oxidized trace from the fresh trace. From this, there does not appear to be any indication of irreversible reduction, which would manifest as the continued presence of an absorption around 700 nm.

This same solution was then reduced by 2 electrons for a 21^{st} time and kept in a container open to air for 44 hours, after which time it appeared to have fully discolored by eye (implying complete re-oxidation). The UV-vis spectrum of this indicates that there are possibly some reduced silicotungstate species remaining in solution: by comparison with the absorbance H₆[SiW₁₂O₄₀] displays at λₘₐₓ at this concentration, any remaining reduced species are present at less than 0.02% of the total silicotungstic acid in solution, i.e. complete re-oxidation is effectively complete after 44 h exposed to air.

### REFERENCES

A number of publications are cited above in order to more fully describe and disclose the invention and the state of the art to which the invention pertains. Full citations for these references are provided below. The entirety of each of these references is incorporated herein.
Amstutz et al. Energy Environ. Sci. 7, 2350 (2014)
Aricò et al, J. Appl. Electrochem. 43, 107-118 (2013)
Ghassemzadehet al., J. Phys. Chem. C 114, 14635-14645 (2010)
Hiskia et al., Inorg. Chem. 31, 163-167 (1992)
Karunadasa et al, Science, 335, 698-702 (2012)
Keita et al. J. Electroanal. Chem. 217, 287-304 (1987)
LaConti et al., ECS Trans. 1, 199-216 (2006)
Launay J. Inorg. Nucl. Chem. 38, 807-816 (1976)
Mamaca et al, Appl. CataL B-Environ. 111-112, 376-380 (2012)
Merki et al. Chem. Sci. 2, 1262-1267 (2011)
Millet et al, Int. J. Hydrogen Energ. 35, 5043-5052 (2010)
Popczun et al, J. Am. Chem. Soc. 135, 9267-9270 (2013)
Pozio et al., Electrochim. Acta 48, 1543 (2003)
Siracusano et al, Int. J. Hydrogen Energ. 37, 1939-1946 (2012)
Smith et al., Electrochim. Acta 53, 2994-3001 (2008)
Symes et al., Nature Chem. 5, 403-409 (2013)
WO 2013/068754
WO 2013/131838
Xu et al., Int. J. Hydrogen Energ. 37, 2985-2992 (2012)

1. A method for the generation of hydrogen, the method comprising the steps of:
(i) reducing a mediator at a working electrode to yield a reduced mediator and generating oxygen at a counter electrode; and
(ii) contacting the reduced mediator with a catalyst, thereby to oxidise the reduced mediator to yield hydrogen.

2. The method of claim 1, wherein step (i) includes oxidising water at the counter electrode to yield oxygen.

3. The method of claim 1, wherein the mediator is a metal oxide.

4. The method of claim 3, wherein the metal oxide is a polyoxometallate.

5. The method of claim 4, wherein the polyoxometallate is of formula {Hₘ[M₁₂O₄₀X]}ⁿ⁻ where m is 0, 1, 2, 3, 4, 5 or 6 as appropriate, M is a metal, such as Mo, W or V, or mixtures thereof, X is P or Si, n is an integer, and where n is not 0, one or more suitable counter ions may be provided.

6. The method of claim 5, wherein the polyoxometallate is of formula HₘM₁₂O₄₀X where m is 3, 4, 5 or 6 as appropriate, M is a metal, such as Mo, W or V, or mixtures thereof, and X is P or Si.

7. The method of claim 6, wherein the polyoxometallate is of formula H₄W₁₂O₄₀Si or H₅W₁₂O₄₀Si.

8. The method of claim 1, wherein the catalyst is a heterogeneous catalyst.

9. The method of claim 1, wherein the catalyst is a metal catalyst, such as a transition metal catalyst.

10. The method of claim 9, wherein the metal catalyst is or comprises a metal selected from the group consisting of Pt, Rh, Pd, Mo and Ni.

11. The method of claim 1, wherein the mediator is prevented from contacting the counter electrode, for example by a membrane.

12. The method of claim 1 wherein the mediator is provided in an acidified aqueous electrolyte.

13. The method of claim 1, wherein the mediator accepts protons during the reduction.

14. The method of claim 1, wherein the reduced mediator donates protons during its catalytic oxidation.

15. The method of claim 1, wherein the oxidised form of the reduced mediator, which is a product of step (ii), is subsequently used as a mediator in step (i).

16. The method of claim 1, wherein the hydrogen produced in step (ii) is substantially free of oxygen.

17. The method of claim 1, wherein hydrogen and oxygen are generated simultaneously.

18. The method of claim 16, wherein the oxygen content is 1 mole % or less.
